(19) United States
(12) Patent Application Publication
(10) Pub. No.: US 2015/0274922 A1
(43) Pub. Date: Oct. 1, 2015

(54) MATERIALS COMPRISING NVR POLYOLS

(71) Applicant: INVISTA NORTH AMERICA S.A.R.L., Wilmington, DE (US)

(72) Inventor: Richard P. Beatty, Newark, DE (US)

(73) Assignee: INVISTA NORTH AMERICA S.A.R.L., Wilmington, DE (US)

(21) Appl. No.: 14/429,984

(22) PCT Filed: Sep. 17, 2013
(86) PCT No.: PCT/US13/60109

§ 371 Date: Mar. 20, 2015

Related U.S. Application Data
(60) Provisional application No. 61/704,167, filed on Sep. 21, 2012.
(60) Provisional application No. 61/709,662, filed on Oct. 4, 2012.
(60) Provisional application No. 61/807,483, filed on Apr. 2, 2013.

(51) Int. Cl. C08J 9/33; C08G 18/42; C08G 18/72; B32B 27/06; C09J 175/06; B29C 67/20; B32B 5/18; C08J 5/04; C08G 18/76

(52) U.S. Cl. CPC C08J 9/33; C08J 5/045; C08G 18/4238; C08G 18/72; C08G 18/7664; C09J 175/06; B29C 67/20; B32B 5/18; B32B 27/065; C08J 2375/04; C08J 2475/06; C08J 2301/02; C08J 2397/02; B29K 2075/00

(57) ABSTRACT

The present disclosure relates to products prepared from polyol compositions, useful as components of polyurethane polymers, produced from non-volatile distillation residues of cyclohexane oxidation reaction byproducts. For example, the disclosure provides polyurethane (PU) polymers made using the polyol compositions and polyfunctional isocyanates. The PU polymers can be used as binders for fiber substances and foams.

### CROSS-REFERENCE TO RELATED APPLICATIONS

This application claims benefit of the filing date of U.S. Provisional Patent Application No. 61/704,167, filed Sep. 21, 2012; U.S. Provisional Patent Application No. 61/709,662, filed Oct. 4, 2012; and U.S. Provisional Patent Application No. 61/807,483, filed Apr. 2, 2013. This application hereby incorporates by reference these provisional applications in their entirety.

### BACKGROUND OF THE INVENTION

As petroleum-based materials escalate in price and environmental pressures increase, there is a growing need to responsibly utilize, to the greatest extent possible, products from petrochemical processes, which includes the byproducts that are unavoidably formed from these processes. Reaction byproducts are often mixtures that may be complex in composition, difficult to use directly, and/or difficult or costly to purify. They are frequently treated as materials of little or no value, being discarded or burned for fuel value.

It is known in the manufacture of adipic acid or caprolactam from cyclohexane that byproduct streams result because the chemical transformations do not proceed perfectly to 100% yield. These byproduct streams contain a variety of molecules having functionalities which include, among others, one or more alcohol, alkene, carboxylic acid, lactone, ester, ketone, or combinations thereof. These byproduct streams are complex mixtures. It is known to use some byproduct streams for their fuel value. With such uses, there is little or no recognition or recovery of value for the functionality present in the byproduct stream. As a result, most of the byproduct streams from adipic acid manufacturing processes remain underutilized.

Manufacture of adipic acid from cyclohexane generally involves two steps. First, cyclohexane is oxidized using air to a mixture of cyclohexanol (A) and cyclohexanone (K), the mixture being referred to as KA. Second, KA is oxidized using nitric acid to adipic acid, a nylon-66 precursor.

A similar “cyclohexane oxidation” step is also performed in manufacture of caprolactam from cyclohexane. In the caprolactam manufacturing process, cyclohexanone is converted to its oxime, which is then caused to undergo molecular rearrangement to yield caprolactam. Caprolactam can then be polymerized to provide nylon-6.

In the known cyclohexane oxidation processes, cyclohexane is generally oxidized with oxygen or a gas containing oxygen, at low conversion, to produce an intermediate stream containing cyclohexanol (A), cyclohexanone (K), and cyclohexyl hydroperoxide (CHHP) in cyclohexane. CHHP is an important intermediate in oxidation of cyclohexane to KA, and various processes are known in the art to optimize conversion of CHHP to KA in order to maximize yield of KA. In addition to KA and CHHP, cyclohexane oxidation produces byproducts. In some cases, it has been found that these byproducts interfere with subsequent processing to convert CHHP to KA.

It is known that at least some of the interfering byproducts can be removed by contacting the intermediate stream containing K, A, and CHHP with water or caustic, for example, as described in U.S. Pat. No. 3,365,490, which is incorporated herein by reference in its entirety. This patent describes air oxidation of cyclohexane, followed by nitric acid conversion to diacids, such as adipic acid, and processing of byproduct waste streams. This contacting, or extraction, results in a two-phase mixture that, after phase separation, yields a purified cyclohexane stream containing K, A, and CHIP (which can be subjected to known high-yield processes to convert CHHP to KA) and a byproduct water stream. The byproduct water stream (“Water Wash”) contains various mono- and di-acids, hydroxy-acids, and other oxidation byproducts formed during the initial oxidation of cyclohexane.

Regardless of whether a water wash is performed as an intermediate step, the stream containing K, A, and CHHP is further processed by methods well known in the art, to complete conversion of CHHP to K and A. The resulting mixture is then refined, again by methods well known in the art, to recover unconverted cyclohexane for recycle and to obtain purified K and A for subsequent oxidation to adipic acid or conversion to caprolactam. To summarize, the byproduct streams, sometimes referred to herein as “by-product” streams, available from a cyclohexane oxidation process include “Water Wash” (the aqueous stream produced by water extraction of cyclohexane oxidate) and “NVR” (the high-boiling distillation bottoms from KA refining), CAS Registry Number 68411-76-7. Concentration of “Water Wash” by removal of at least some of the water produces a stream known as “COP Acid,” CAS Registry Number 68915-38-8. See also published US patent applications US2004/0054235 describing production of “non-volatile residue,” high-boiling distillation bottoms from distillative recovery of cyclohexane oxidation products cyclohexanol and cyclohexanone, termed “NVR,” having low chromium content, more suitable for combustion, US2012/0064252 and US2012/0101009, which are incorporated herein by reference, describing processing of NVR, Water Wash, or COP acid through conversion of free acid functional groups to monomeric esters and oligomeric esters, and converting oligomeric esters to monomeric esters.

“Water Wash,” “COP Acid,” and “NVR” are known to contain both mono- and poly-functional materials (functional monomers), mainly with the functional groups comprising acids, peroxides, ketones, alcohols, and esters. Other functional groups such as aldehyde, lactone, and alkene are also known to be present. Multiple functional groups may be combined in a single molecule, such as in a hydroxyacid, for example, hydroxycaproic acid or hydroxyvaleric acid. In general, the acid functional group is at one end of a linear hydrocarbyl chain, and the hydroxy group may be present in various positions along the chain. The mono- and poly-functional materials contained within these byproduct streams are primarily aliphatic. Known examples of hydroxyacids include 6-hydroxycaproic acid, 5-hydroxyvaleric acid, 3-hydroxyvaleric acid, and 3-hydroxypropionic acid. Similarly, known examples of simple mono-acids include formic acid, acetic acid, propionic acid, butyric acid, valeric acid, and caproic acid. Known examples of diacids include succinic acid, glutaric acid, and adipic acid. Known examples of keto-acids include 4-oxo valeric acid (also known as levulinic acid) and 5-oxo caproic acid. Known examples of alcohols include cyclohexanol, 1-propanol, 1-butanol, 1-pentanol, and various diols such as 1,2- 1,3-, and 1,4-cyclohexanediols, various butanediol isomers, and various pentanediol isomers.

### SUMMARY OF THE INVENTION

It has been recognized that it would be advantageous to develop polyols, pre-polymer compositions, polyurethane polymers, and associated products, from an NVR byproduct stream from cyclohexane oxidation reactions.

In one embodiment, a method of manufacturing foam padding can comprise obtaining a pre-polymer composition, the pre-polymer composition comprising a polyol and a polyfunctional monomer, the polyol prepared by heating a byproduct mixture containing a non-volatile residue of a cyclohexane oxidation reaction product to remove monofunctional components to a concentration of about 0.01 wt % to about 26 wt % and water by distillation, the polyol further prepared by reacting the non-volatile residue of a cyclohexane oxidation reaction product with one or more polyhydroxy compounds; mixing the pre-polymer composition with a chopped foam; molding the chopped foam and the pre-polymer composition into a shape; and curing the pre-polymer composition. The polyfunctional monomer may be a polyfunctional isocyanate, including an isocyanate-functional prepolymer. The chopped foam may be scrap or recycled foam that has been cut or chopped into pieces of the desired size.

Additionally, a foam padding can comprise chopped foam; and a polyurethane binder polymerized from a polyol and a polyfunctional monomer, the polyurethane binder containing monofunctional components including butyric acid, valeric acid, and caproic acid, the monofunctional components present in the polyurethane binder in an amount from about 0.01 wt % to about 26 wt %.

In another embodiment, a method of manufacturing a fiber-reinforced composite material can comprise preparing a pre-polymer composition, the pre-polymer composition comprising a polyol and a polyfunctional monomer, the polyol prepared by heating a byproduct mixture containing a non-volatile residue of a cyclohexane oxidation reaction product to remove monofunctional components to a concentration of about 0.01 wt % to about 26 wt % and water by distillation, the polyol further prepared by reacting the non-volatile residue of a cyclohexane oxidation reaction product with one or more polyhydroxy compounds; contacting a fiber substance with the pre-polymer composition; and curing the pre-polymer composition.

Additionally, a fiber-reinforced composite material can comprise: a fiber substance; and a polyurethane binder polymerized from a polyol and a polyfunctional monomer, the polyurethane binder containing monofunctional components including butyric acid, valeric acid, and caproic acid, the monofunctional components present in the polyurethane binder in an amount from about 0.01 wt % to about 26 wt %.

In still another embodiment, a resin blend can comprise: a polyol, the polyol containing monofunctional components including butyric acid, valeric acid, and caproic acid, where the monofunctional components are present in the polyurethane binder in an amount from about 0.01 wt % to about 26 wt %.

Further, a pre-polymer composition can comprise a resin blend and a polyfunctional monomer.

### DETAILED DESCRIPTION OF THE INVENTION

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the suitable methods and materials are now described.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, foam chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 20° C. and 1 atmosphere absolute.

As used in this specification and the appended claims, the singular forms “a,” “an,” and “the” include plural referents unless the context clearly dictates otherwise. Thus, for example, reference to “a polyol” includes a plurality of polyols. In this specification and in the claims that follow, reference will be made to a number of terms that shall be defined to have the following meanings unless a contrary intention is apparent.

As mentioned, all percent compositions are given as weight-percentages, unless otherwise stated. When solutions of components are referred to, percentages refer to weight-percentages of the composition including the solvent (e.g., water) unless otherwise indicated.

All molecular weights of polymers are weight-average molecular weights, unless otherwise specified.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range includes “about ‘x’ to about ‘y’”. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

The term “hydroxyl value” indicates the total amount of residual hydroxyl groups present in the material. The hydroxyl value, also referred to herein as hydroxyl number, is reported as mg KOH/g (i.e., mg KOH per gram of sample), and is measured according to well-known methods such as standard ASTM D 1957 or ASTM E1899.

The term “average functionality,” or “average hydroxyl functionality” of a polyol indicates the number of OH groups per molecule, on average. The average functionality of an isocyanate refers to the number of —NCO groups per molecule, on average.

The term “acid number” correspondingly indicates the concentration of carboxylic acid groups present in the material, and is reported in terms of mg KOH/g (i.e., mg KOH per gram of sample), and measured according to well-known methods such as standard ASTM D 4662 or ASTM D1613.

The amount of isocyanate (—NCO) present in the pre-polymer composition may be expressed in terms of an “isocyanate reaction index”, also called “isocyanate index,” “NCO index” or simply “index.” Herein and conventionally in the art, an isocyanate reaction index of 100 corresponds to 1.0 isocyanate group (—NCO) per active hydrogen atom. Additional details regarding the NCO index are described in U.S. Pat. No. 6,884,824, which is incorporated herein by reference. Typical Isocyanate Indexes for sprayed polyurethane (PU) foam ranges from about 110 to 120. Additionally, the Isocyanate Index is defined as the measure of the excess isocyanate used relative to the theoretical equivalent amount required. For example, an index of 105 indicates a 5% excess of isocyanate is being used.

The term “aliphatic group” refers to a saturated or unsaturated linear or branched hydrocarbon group and encompasses alkyl, alkenyl, and alkynyl groups, for example.

The terms “polyol” or “aliphatic polyol” refer to a polyol prepared from a mixture of aliphatic functional monomers (byproducts) from a cyclohexane oxidation process, with average functionality greater than 1. Such polyols can be prepared from non-volatile residues that are byproduct streams resulting from cyclohexane oxidation processes.

The term “polyurethane polymer” refers to polymer synthesized from polyols and polyisocyantes and generally includes polyisocyanurate polymers, unless the context clearly dictates otherwise.

The terms “alk” or “alkyl” refer to straight or branched chain hydrocarbon groups, which can have from 1 to 20 carbon atoms, such as from 1 to 12 carbon atoms, or for example, 1 to 8 carbon atoms, including groups such as methyl, ethyl, n-propyl, propyl, n-butyl, i-butyl, t-butyl, pentyl, hexyl, heptyl, n-octyl, dodecyl, amyl, 2-ethylhexyl, and the like. An alkyl group can optionally be substituted, unless stated otherwise, with one or more groups, selected from aryl (optionally substituted), heterocyclo (optionally substituted), carbocyclo (optionally substituted), halo, hydroxy, protected hydroxy, alkoxy (e.g., C₁ to C₇) (optionally substituted), poly(oxyalkylene) (e.g., ethoxylated or propoxylated groups), acyl (e.g., C₁ to C₇), aryloxy (optionally substituted), alkylester (optionally substituted), arylester (optionally substituted), alkanoyl (optionally substituted), aroyl (optionally substituted), carboxy, protected carboxy, cyano, nitro, amino, substituted amino, (monosubstituted)amino, (disubstituted)amino, protected amino, amido, lactam, urea, urethane, sulfonyl, and the like.

The terms “aromatic”, “ar”, or “aryl” refer to aromatic homocyclic (i.e., hydrocarbon) mono-, bi-, or tricyclic ring-containing groups, for example, having 6 to 12 members such as phenyl, naphthyl, and biphenyl. An aryl group is optionally substituted, unless stated otherwise, with one or more groups, selected from alkyl (optionally substituted alkyl), alkenyl (optionally substituted), aryl (optionally substituted), heterocyclo (optionally substituted), halo, hydroxy, alkoxy (optionally substituted), poly(oxyalkylene) (e.g., ethoxylated or propoxylated groups), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and the like. Optionally, adjacent substituents, together with the atoms to which they are bonded, form a 3- to 7-member ring.

The term or phrases “monofunctional components” or “monofunctional compounds” refers to compounds in free form, or bound to other compounds by ester bonds, where each monofunctional component or compound contains only a single reactive functional group. For example, methanol is a free monofunctional component, and a methyl ester of a diacid is a bound monofunctional component. The terms are to be understood in the context in which they are used. For example, in the context of preparing a polyol, reactive groups would include carboxylic acid and hydroxyl groups since those are capable of reacting with the complementary functional group in another monomeric compound to form an ester linkage. Non-reactive functional groups such as ketone or alkene are not included in determination of whether a component is monofunctional, since such groups do not participate in forming a polyol. In other words, a monomeric compound containing one hydroxyl group and one ketone group would be considered a monofunctional compound in the context herein. Similarly, a monomeric compound containing one hydroxyl group would be considered a monofunctional compound in the context herein.

Monofunctional components or compounds (e.g., mono-acids, mono-alcohols, and the like) can include bound and/or unbound and include: formic acid, acetic acid, cyclohexanol (e.g., bound can include cyclohexanol bound to adipic acid), propionic acid, butyric acid, valeric acid, caproic acid, propanol (e.g., 1-propanol and 2-propanol), butanol (e.g., 1-butanol, 2-butanol, etc.), pentanol (e.g., 1-pentanol, 2-pentanol, etc.), hexanol (e.g., 1-hexanol, 2-hexanol, etc.), and the like. Reference to “removing monofunctional components” monofunctional compounds, such as “removing free and bound monofunctional components” refers to removing from the mixture referred to, such as by heating and distillation, both free monofunctional components (e.g., monocarboxylic acids, mono-hydroxy compounds, and the like), and those products that can be derived from cleavage of bound monofunctional components under the conditions of removal (e.g., heat, vacuum, acid catalysis) to yield free monofunctional components in the course of the process step, which are then removed by distillation or the like along with the free monofunctional components.

A “polyfunctional” or “polyfunctional compound” as used herein, refers to compounds that have more than a single functional group capable of forming new bonds under the conditions of heating and, optionally, catalysis as disclosed herein. Examples include diacids, diols, hydroxyacids, hydroxyesters, and the like.

As mentioned, pressures reported as pounds per square inch gauge (psig) are relative to one atmosphere. 1 pound per square inch=6.895 kilopascal. One atmosphere is equivalent to 101.325 kilopascals, and one atmosphere is about 14.7 pounds per square inch absolute (psia) or about 0 pounds per square inch gauge (psig). Unless otherwise stated, vacuum is in mm Hg, where 1 atm absolute=760 mm Hg.

The term “about” as used herein, when referring to a numerical value or range, allows for a degree of variability in the value or range, for example, within 10%, or, in one aspect within 5%, of a stated value or of a stated limit of a range.

In addition, where features or aspects of the disclosure are described in terms of a list or a Markush group, those skilled in the art will recognize that the disclosure is also thereby described in terms of any individual member or subgroup of members of the Markush group. For example, if X is described as selected from the group consisting of bromine, chlorine, and iodine, claims for X being bromine and claims for X being bromine and chlorine are fully described as if listed individually. For example, where features or aspects of the disclosure are described in terms of such lists, those skilled in the art will recognize that the disclosure is also thereby described in terms of any combination of individual members or subgroups of members of list or Markush group. Thus, if X is described as selected from the group consisting of bromine, chlorine, and iodine, and Y is described as selected from the group consisting of methyl, ethyl, and propyl, claims for X being bromine and Y being methyl are fully described.

If a value of a variable that is necessarily an integer, e.g., the number of carbon atoms in an alkyl group or the number of substituents on a ring, is described as a range, e.g., 0-4, what is meant is that the value can be any integer between 0 and 4 inclusive, i.e., 0, 1, 2, 3, or 4.

In various embodiments, the compound or set of compounds, such as are used in the inventive methods, can be any one of any of the combinations and/or sub-combinations of the above-listed embodiments.

In various embodiments, a compound as shown in any of the Examples, or among the exemplary compounds, is provided. Provisos may apply to any of the disclosed categories or embodiments wherein any one or more of the other above disclosed embodiments or species may be excluded from such categories or embodiments.

Phrases such as “under conditions suitable to provide” or “under conditions sufficient to yield” or the like, in the context of methods of synthesis, as used herein refers to reaction conditions, such as time, temperature, solvent, reactant concentrations, and the like, that are within ordinary skill for an experimenter to vary, that provide a useful quantity or yield of a reaction product. It is not necessary that the desired reaction product be the only reaction product or that the starting materials be entirely consumed, provided the desired reaction product can be isolated or otherwise further used.

The term “chemically feasible” describes a bonding arrangement or a compound where the generally understood rules of organic structure are not violated; for example, a structure within a definition of a claim that would contain in certain situations a pentavalent carbon atom that would not exist in nature would be understood to not be within the claim. The structures disclosed herein, in all of their embodiments are intended to include only “chemically feasible” structures, and any recited structures that are not chemically feasible, for example, in a structure shown with variable atoms or groups, are not intended to be disclosed or claimed herein.

### Non-Volatile Residue (NVR)

A new simple and economical process has been discovered that provides polyols of new and unique composition from cyclohexane oxidation byproducts. It has further been found that these polyols can be used to prepare new and unique polyurethanes, and that the polyurethanes thereby obtained are useful in a wide variety of applications. By using a process described herein, it is not necessary to first separate individual monomers, such as adipic acid, from the cyclohexane oxidation byproducts. Surprisingly, the complex mixtures can be used directly in a simple process that affords useful polyols. This discovery is of great value because it can eliminate the need for costly and complicated purification or separation processes.

More particularly, the current disclosure is focused on utilization of the NVR byproduct stream from the oxidation of cyclohexane to cyclohexanone and cyclohexanol, or KA. Notably, the polyol compositions of the disclosure can be used as components of resin blends that can be combined with coreactants, catalysts, and other ingredients to provide pre-polymer compositions, which then can undergo polymerization to provide polymer materials useful as binders, and the like.

The NVR byproduct stream can be converted to polyol compositions, which can then be used in the production of resin blends and polyurethane polymers directly, e.g., by the “one-shot” method wherein polyol and isocyanate are reacted in one step or via pre-polymer compositions wherein polyol is allowed to react with excess isocyanate to form an isocyanate-functional prepolymer that is later allowed to react with chain extenders or crosslinkers to form a final polyurethane. The polyols, resin blends, pre-polymers, and final polyurethane polymer compositions are useful in the various products such as binders, and the like. NVR can contain about 10% to 50% by weight water.

Generally, NVR can include monofunctional and polyfunctional byproducts of the cyclohexane oxidation reaction or process, in free and/or bound form. By “free form,” what is meant is that the monofunctional compounds are not bound covalently to other compounds through bonds (e.g., ester bonds) subject to cleavage in the heating and distillation process, optionally in the presence of a transesterification catalyst. By “bound form,” what is meant is that the monofunctional compounds are bound by covalent bonds subject to cleavage in the heating and distillation process (e.g., ester bonds), optionally in the presence of a transesterification catalyst. In the heating process, free monofunctional compounds present in the byproduct mixture can distill out of the mixture. Bound monofunctional compounds can undergo hydrolysis or transesterification, liberating the free form of the monofunctional compounds, which then can also be removed from the mixture by distillation.

The types of functional group(s) present in the organic components of the compounds present in a byproduct mixture of a cyclohexane oxidation reaction can include: an acid (e.g., a monobasic carboxylic acid and a dibasic carboxylic acid), a ketone (e.g., an aliphatic or cycloaliphatic ketone), an alcohol (e.g., an aliphatic alcohol, a cycloaliphatic alcohol), an ester (e.g., an aliphatic ester, a cycloaliphatic ester), an aldehyde (e.g., an aliphatic aldehyde, aldehyde-acid), a lactone (e.g., an aliphatic lactone), and an alkene (e.g., a keto-alkene, an alkene acid, an alkene alcohol); or a combination of the same or different functional groups in a single molecule (e.g., a hydroxyacid, a di-acid, a keto-acid, an aldehyde-acid, or a diol).

For example, in the byproduct mixture, prior to heat treatment, monoacids (monofunctional compounds) can include: formic acid, acetic acid, propionic acid, butyric acid, valeric acid, caproic acid, and the like. These can be present in free form, or in bound form as formates, acetates, propionates, and similar esters with hydroxy compounds. Diacids can include malonic acid, succinic acid, glutaric acid, adipic acid, fumaric acid, maleic acid, oxalic acid, hex-2-enedioic acid, and the like. These can be present in free or in bound forms also, but are generally not removed by distillation to any significant extent in the step of heating. Ketones can include cyclohexanone, cyclopentanone, and the like.

Keto-acids can include an alpha-keto acid (e.g., a 2-oxo acid such as pyruvic acid), a beta-keto acid (e.g., a 3-oxo acid such as acetoacetic acid), a gamma-keto acid (e.g., a 4-oxo acid such as levulinic acid), a 5-oxo caproic acid, and the like. Keto-acids containing only one carboxylic acid group and no hydroxyl groups, such as the above examples, are considered monofunctional compounds herein, and can be reduced during the heating/distillation process.

In the byproduct mixture, prior to heat treatment, monofunctional alcohols can include cyclohexanol, propanol (e.g., 1-propanol and 2-propanol), butanol (e.g., 1-butanol, 2-butanol, etc.), pentanol (e.g., 1-pentanol, 2-pentanol, etc.), hexanol (e.g., 1-hexanol, 2-hexanol, etc.). These can be present in free form, and can also be present in bound form, e.g., in combination with carboxylic acid groups as esters thereof. In the byproduct mixture, diols can include cyclohexanediols of various positional isomers such as 1,2-, 1,3-, and 1,4-cyclohexanediols, a butanediol isomer, a pentanediol isomer, and the like.

The components of the NVR byproduct stream can include monofunctional compounds, both free and bound, and polyfunctional compounds, including alcohols, carboxylic acids, and other types of functional compounds such as ketones, aldehydes, other oxygenates. The alcohols may form ester and/or polyester linkages with an acid functional group present in NVR. When the carboxylic acid is a mono-carboxylic acid, or the alcohol is a mono-ol, the acid or alcohol moiety respectively is a bound monofunctionally, that group can be liberated and removed during the step of heating and distillation, optionally in the presence of a catalyst such as an acid or an organometallic compound. When the carboxylic acid is a diacid, or the alcohol is a diol, the polyfunctional compounds can become incorporated into the polyol composition of the disclosure. For components of the byproduct mixture that have two different reactive functional groups, these can also become incorporated into the polyol composition of the disclosure by the processing steps disclosed and claimed herein. For example, a hydroxyacid can form ester or polyester linkages with themselves or with other polyfunctional materials present in the mixture. More specifically, adipic acid can form an ester linkage (e.g., condensation reaction product) with the alcohol function in hydroxycaproic acid. In an embodiment, hydroxycaproic acid may form an ester linkage (e.g., condensation reaction product) with the alcohol function in another hydroxycaproic acid. Then, such diesters can themselves undergo transesterification with removal of monofunctional alcohols and formation of esters with polyhydroxy components like glycols.

A hydroxyacid can include hydroxycaproic acid, hydroxyvaleric acid, hydroxybutryic acid, hydroxypropionic acid, or hydroxyacetic acid. In an embodiment, the acid functional group is at one end of a linear chain (e.g., a hydrocarbyl chain) and the hydroxy group is at the other end of the chain. In an embodiment, the acid functional group is at one end of a linear chain (e.g., a hydrocarbyl chain) and the hydroxy group may be present in various positions along the chain. The hydroxycaproic acid can include 2-hydroxy-caproic acid, 3-hydroxycaproic acid, 4-hydroxycaproic acid, 5-hydroxy-caproic acid, and 6-hydroxycaproic acid, in which the hydroxyl group can be free, or can be bonded to a bound monoacid, or a bound polyacid. The hydroxyvaleric acid can include 2-hydroxyvaleric acid, 3-hydroxyvaleric acid, 4-hydroxyvaleric acid, and 5-hydroxyvaleric acid. The hydroxybutyric acid can include 2-hydroxybutyric acid, 3-hydroxybutyric acid, and 4-hydroxybutyric acid. The hydroxypropionic acid can include 2-hydroxypropionic acid and 3-hydroxypropionic acid.

Byproduct mixtures from two or more different reaction, e.g., one from adipic acid production and the other from caprolactam production, can be combined into a single byproduct mixture, which can be further processed into a polyol composition of the disclosure.

### Polyol Methods and Compositions

The process of heating, optionally in the presence of a catalyst such as a transesterification or hydrolysis catalyst, has been found to bring about rearrangement among the various free and bound forms of compounds present in the byproduct mixture, in particular, of carboyxlic acid and their esters, and hydroxy compounds (alcohols) and their esters. Bonds are broken and formed, and, it has been unexpectedly discovered that with reduction of monofunctional compounds by distillation, the product remaining can comprise a polyol composition of the disclosure, useful for preparation of polyurethane (PU) polymers for various applications.

Generally, such polyol compositions contain monofunctional components including butyric acid, valeric acid, and caproic acid in an amount from about 0.01 wt % to about 26 wt %. In one embodiment, the butyric acid can be present in an amount from about 0.01 wt % to about 5 wt %, the valeric acid can be present in an amount from about 0.05 wt % to about 15 wt %, and the caproic acid can be present in an amount from about 0.01 wt % to about 6 wt %. In another aspect, the butyric acid can be present in an amount from about 0.05 wt % to about 2 wt %, the valeric acid can be present in an amount from about 0.2 wt % to about 10 wt %, and the caproic acid can be present in an amount from about 0.5 wt % to about 5 wt %. In still another aspect, the butyric acid can be present in an amount from about 0.1 wt % to about 1 wt %, the valeric acid can be present in an amount from about 1 wt % to about 8 wt %, and the caproic acid can be present in an amount from about 1 wt % to about 4 wt %. In still another aspect, the butyric acid can be present in an amount from about 0.2 wt % to about 0.8 wt %, the valeric acid can be present in an amount from about 2 wt % to about 7 wt %, and the caproic acid can be present in an amount from about 1.5 wt % to about 3.5 w t %.

Additionally, the polyol compositions can contain levulinic acid and further contain multifunctional compounds including hydroxycaproic acid and adipic acid. In one embodiment, the levulinic acid can be present in an amount from about 0.01 wt % to about 5 wt %, the hydroxycaproic acid can be present in an amount from about 3 wt % to about 45 wt %, and the adipic acid can be present in an amount from about 3 wt % to about 35 wt %. In another aspect, the levulinic acid can be present in an amount from about 0.05 wt % to about 4 wt %, the hydroxycaproic acid can be present in an amount from about 4 wt % to about 40 wt %, and the adipic acid can be present in an amount from about 4 wt % to about 30 wt %. In another aspect, the levulinic acid can be present in an amount from about 0.5 wt % to about 2 wt %, the hydroxycaproic acid can be present in an amount from about 5 wt % to about 35 wt %, and the adipic acid can be present in an amount from about 5 wt % to about 25 wt %. In still another aspect, the levulinic acid can be present in an amount from about 0.75 wt % to about 1.75 wt %, the hydroxycaproic acid can be present in an amount from about 10 wt % to about 30 wt %, and the adipic acid can be present in an amount from about 10 w t % to about 25 wt %.

When this transesterification and reduction of monofunctional components is carried out in the presence of a polyhydroxy compound, e.g., a glycol, a triol, a tetraol, or a higher polyol, the resulting composition has been found to have favorably low acid numbers and favorably high OH values to serve as polyol compositions suitable for, inter alia, the preparation of pre-polymer compositions with polyisocyanates, which mutually react and polymerize to form polyurethane polymers of the disclosure.

Accordingly, a method of preparing a polyol composition can comprise heating a byproduct mixture comprising a non-volatile residue (NVR) of a cyclohexane oxidation reaction product to reduce monofunctional components and water by distillation, and further comprise reacting the NVR with one or more polyhydroxy compounds. In one embodiment, the NVR can be concentrated prior to reacting. In one aspect, a catalyst can be used. Additionally, in one embodiment, the heating can be under vacuum or can include an inert gas sparge. Additionally, in one embodiment, the heating can be under vacuum and can include an inert gas sparge.

A method of the disclosure can also further comprise a step of heating the byproduct mixture, optionally under vacuum, or optionally with an inert gas sparge, to reduce monofunctional components and water, prior to adding the one or more polyhydroxy compounds, then, after adding the one or more polyhydroxy compounds, continuing to heat the resulting mixture. Upon this additional step of heating and distilling, optionally in the presence of a catalyst such as is suitable for transesterification reactions, prior to addition of the polyhydroxy compound takes place, it is believed that ester formation and transesterification takes place between the polyfunctional components of the byproduct mixture, as the monofunctional components are removed by distillation. Then, upon addition of the polyhydroxy compound, e.g., a glycol, triol, etc., and further heating, optionally in the presence of the same catalyst or another catalyst, further esterification and transesterification takes place along with distillative reduction of monofunctional components along with water. The amount of polyhydroxy compound used can be about 3% to 50% by weight. Reduction of water and monofunctionals can help drive the formation of esters from polyfunctional acids present in the byproduct mixture and the added polyhydroxy compounds.

The heating and distillation process following addition of the polyhydroxy component can continue for any suitable period to accomplish removal of water and monofunctional components to a desired amount, for example, the distillation process can continue until a remaining content of the monofunctional compounds, following the step of heating and removal thereof by distillation, is about 10% or less, or is about 5% or less, or is about 2% or less, by weight, of the composition. For some end uses, a more complete removal of monofunctionals can be favored, whereas for other end uses, the removal need not be as stringent. This can be determined by the end-user for the specific application.

Addition of a catalyst, or of more than a single catalyst, can facilitate the esterification and particularly the transesterification of the various carboxlic acid and hydroxylated components of the byproduct mixture and of the added polyhydroxy compound. As is known in the art, catalysts reduce the activation barrier for a reaction to occur and, in conjunction with heating and distillative removal of water and monofunctional components, the presence of a catalyst can more quickly and effectively enable the reaction mixture to reach a favorable condition of condensation of its polyfunctional components to provide a polyol composition of suitable properties for the desired use. The catalyst can be a transesterification or a hydrolysis catalyst such as an acid or an organometallic compound, as is discussed in greater detail below.

A polyol composition of the disclosure can be made by reducing water and monofunctional compounds from a byproduct mixture, such as described above. In an embodiment, the process includes heating (e.g., at about 100 to 300° C., or at about 150° C. to 250° C., or at about 180° C. to 200° C., or at about 235° C.) a mixture of functional monomers from a non-volatile residue (NVR), and reducing monofunctional components and, optionally, water, to form the inventive polyol composition. In one embodiment, heating is used in combination with vacuum (e.g. 10-400 mm Hg, or 40-300 mm Hg, or 300 mm Hg, or 50 mm Hg). In another embodiment, heating is used in combination with sparging, or introduction of a gaseous substance beneath the liquid surface of the mixture to enhance removal of water and monofunctional compounds (e.g. an inert gas such as nitrogen, or superheated steam).

The monofunctional compounds and any associated water can be reduced using the process (or system) such as distillation, a vapor-liquid separation (e.g., single-stage flash separation, evaporation (short-path, wiped, falling film, atmospheric, sub-atmospheric), a multi-stage distillation, multiple instances of these, or combinations of these), a liquid-liquid separation by differential solubility, a solid-liquid separations (e.g., fractional crystallization), separation by molecular size and shape (e.g., membrane separation), post treatments (e.g., carbon decolorizing, clay treatments, and the like), and combinations of each of these (e.g., extractive distillation, distillation followed by post treatments, and the like).

The polyhydroxy component can be selected for production of a polyol composition based upon the desired properties of the polyol composition. Any suitable polyhydroxy compound can be used; for example, the polyhydroxy compound can be a dihydroxy compound (diol), trihydroxy compound (triol), a tetrahydroxy compound (tetraol), a saccharide, a sugar alcohol, a higher polyhydroxy compound, or a mixture thereof. More specifically, the polyhydroxy compound can be at least one of ethylene glycol, diethylene glycol, polyethylene glycol, propylene glycol, dipropylene glycol, polypropylene glycol, butanediol, pentanediol, hexanediol, glycerine, trimethylolpropane, pentaerythritol and sorbitol.

While not wishing to be bound by theory, it is believed that polyols suitable for use as a component of a PU polymer can arise through transesterification of, e.g., esters of compounds such as the adipoylhydroxycaproate with the polyhydroxy compounds, such as by a process exemplified with diethyleneglycol, shown below in Scheme 1, wherein the R group is either hydrogen or is a monovalent organic radical, e.g., cyclohexyl, that yields a monofunctional alcohol, ROH, e.g., cyclohexanol, on hydrolysis. Byproduct monofunctional alcohols, e.g., cyclohexanol, is removed, e.g., by distillation. This reaction is illustrative of the sorts of reactions that can occur under conditions of esterification and transesterification, optionally in the presence of a suitable catalyst, under conditions of heating and distiallative removal of water and monofunctional components.

When R is other than hydrogen, Scheme 1 shows an example of a monofunctional hydroxy compound ROH bound to a polyfunctional carboxylic acid in reaction with diethylene glycol, that is, a transesterification reaction yielding a bis(diethyleneglycol) ester of the dicarboxylic acid. The monofunctional hydroxyl compound ROH is released and can be removed by distillation.

Related reactions involving other monofunctional compounds, such as monoacids shown below in Scheme 2. Scheme 2 illustrates displacement of a bound monofunctional carboxylic acid (valeric acid) by a polycarboxylic acid (adipic acid), following which the liberated valeric acid can be removed by distillation and the remaining adipoyl hydroxycaproate reacted with diethyleneglycol to form a polyol polyester, water of esterification (not illustrated) being removed by distillation.

Under the conditions of heating and reduction of monofunctional components, optionally in the presence of a catalyst suitable for catalyzing esterification and transesterification, reduction of the monofunctional components, e.g., monofunctional acids and alcohols, results in the equilibriums being driven towards formation of esters between only polyfunctional components. Added polyhydroxy compounds, such as glycols, further enter into this set of reactions, such that carboxylic acids become esterified with at least one hydroxyl group of a polyhydroxy compound. For example, in when a glycol is used, one hydroxyl group can become esterified with a carboxylic acid group from a polyfunctional acid, and the other hydroxyl group can remain unesterified, thus resulting in a composition containing terminal hydroxyl groups and comprising ester bonds. In practice the stoichiometry of the reacting mixture is controlled to produce hydroxyl-terminated polyesters of a desired molecular weight. Such hydroxyl groups are then available for reaction with isocyanates to form urethane bonds in PU polymers.

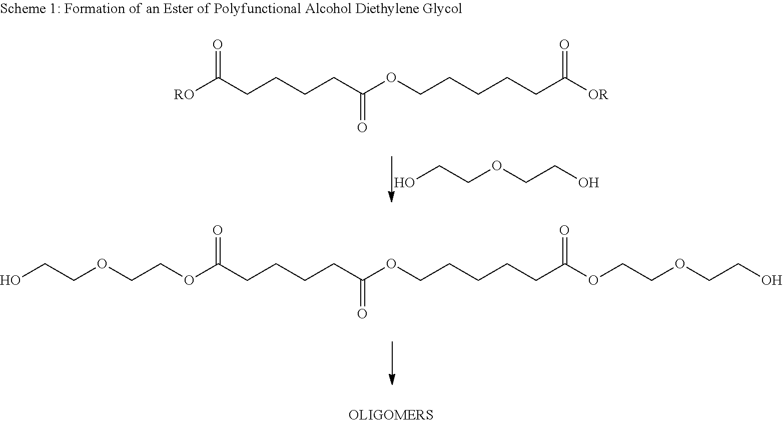

In the above example, when R is H, the reaction of the diethylene glycol with the dicarboxylic acid is an esterification, and water is released, which can be removed by distillation. When R is a group such as an alkyl group or a cycloalkyl group, the reaction with diethylene glycol is a transesterification, and the monofunctional alcohol, e.g., cyclohexanol, is released and then reduced or removed by distillation.

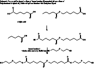

Thus, one polyol produced by a method of this disclosure is a dihydroxy-triester, which can be categorized as a polyol-polyester. Further transesterification steps can take place to provide mixed oligomers of higher molecular weight. Other difunctional, trifunctional, and higher polyfunctional esters, remaining in the byproduct mixture after removal of the monofunctional components, can likewise undergo transesterification reactions with the various polyhydroxy compounds as disclosed and claimed herein to provide various species of polyol-polyester, useful for condensation with diisocyanates, triisocyanates, and higher polyisocyanates to provide PU polymers of the disclosure, as further described below.

The reduction of monofunctional components decreases the concentration of chain terminating moieties in the mixture being heated; for example, bound monofunctional components like esters of monofunctional alcohols or of monofunctional carboxylic acids would serve to eliminate a reactive group on a molecular terminus, because such esters do not include further functionality that could react, e.g., with isocyanates, to form carbamate (urethane) bonds. However, by displacing and reducing monofunctional compounds from the milieu, esterification can take place with a difunctional or trifunctional, or higher polyfunctional compound (glycols, polycarboxylic compounds, hydroxyesters, etc), forming esters that have further functionality that will be available for urethane bond formation in a subsequent process to form a polyurethane polymer. Thus, reduction of monofunctional components can serve to increase chain length and available reactive functionality of the polyol compositions of the disclosure.

A third component comprising a polyfunctional acid, or an activated ester thereof, or a polyfunctional ester or an anhydride thereof, or a combination thereof, can also be added to the mixture, whereupon monofunctional components can be reduced by distillation, to a level of 10% or less, or 5% or less, or 2% or less on a weight basis. By a “polyfunctional acid,” what is meant is a carboxylic acid having two or more carboxylate groups. By an “activated ester thereof,” what is meant is an ester of a polyfunctional acid that can undergo transesterification or hydrolysis under the conditions of heating of the byproduct mixture. By a “polyfunctional ester thereof,” what is meant is an ester of the polyfunctional carboxylic acid with one or more polyfunctional alcohols, such as a glycol ester. By an “anhydride thereof,” what is meant is an intramolecular or intermolecular anhydride of one or two, respectively, polycarboxylic acids as defined above.

For instance, the third component can comprise, or can be, a polyfunctional aromatic acid, or an anhydride thereof, or an activated ester thereof, or a polyfunctional ester thereof, or a mixture thereof. More specifically, the polyfunctional aromatic acid, the activated ester thereof, the polyfunctional ester thereof, or the anhydride thereof, can comprise, or can be at least one of terephthalic acid, isophthalic acid, orthophthalic acid, trimellitic acid, pyromellitic acid, an activated ester thereof and an anhydride thereof. The amount of third component used can be about 1%-30% by weight.

For instance, the third component can comprise, or can be, a polyfunctional aliphatic acid, or an activated ester thereof, or a polyfunctional ester thereof; or an anhydride thereof; or a mixture thereof. More specifically, the third component can comprise, or can be, citric acid, malic acid, aspartic acid, furmaric acid, maleic acid, succinic acid, glutaric acid, adipic acid, or dodecanedioic acid; or an activated ester thereof; or a polyfunctional ester thereof; or an anhydride thereof; or a mixture thereof. The amount of third component used can be about 1%-30% by weight.

The selection of the identity of the third component comprising a polyfunctional carboxylic acid can impact the properties of products using the polyol composition of the present disclosure.

In preparing a polyol composition, a polyfunctional crosslinker or chain extender with two or more reactive hydroxyl or amino functionalities can be added during the heating/distillation stage. For example, the polyfunctional crosslinker or chain extender can be ethylene glycol, diethylene glycol, triethylene glycol, propylene glycol, dipropylene glycol, tripropylene glycol, 1,3-propanediol, 1,3-butanediol, 1,4-butanediol, 1,6-hexanediol, cyclohexane dimethanol, hydroquinone bis(2-hydroxyethyl)ether, neopentyl glycol, glycerol mono-oleate, ethanolamine, diethanolamine, triethanolamine, methyl diethanolamine, phenyl diethanolamine, trimethylolpropane, 1,2,6-hexanetriol, pentaerythritol, N,N,N′,N′-tetrakis-(2-hydroxypropyl) ethylenediamine, diethyltoluenediamine, or dimethylthiotoluenediamine; or any mixture thereof.

More specifically, the polyfunctional crosslinker or chain extender can have three or more reactive hydroxyl or amino functionalities; for example, the polyfunctional crosslinker or chain extender can be glycerol, triethanolamine, trimethylolpropane, 1,2,6-hexanetriol, pentaerythritol, or N,N,N′,N′-tetrakis-(2-hydroxypropyl) ethylenediamine; or any mixture thereof.

In practicing a method of the present disclosure, use of a catalyst, such as a transesterification catalyst, can increase the rate and completeness of the reactions involved in producing the polyol composition. For example, the catalyst can be an acid, e.g., toluenesulfonic acid or xylenesulfonic acid; or the catalyst can be a carboxylate salt, e.g., potassium acetate or potassium octoate; or the catalyst can comprise an organometallic compound, e.g., an organomercury, organolead, organoferric, organotin, organobismuth, or organozinc compound. More specifically, the organometallic compound can be tetraisopropyl titanate or dibutyl tin dilaurate, which are effective as transesterification catalysts. The specific catalyst and concentration used are determined by methods known to those skilled in the art. The catalyst is typically about 0.01 to 1% by weight of the resin blend composition, but may be higher or lower as required according to catalyst activity.

An additional component that can be added to the byproduct mixture can include a hydrophobic material, the addition of which can be followed by heating and removing monofunctional components by distillation. Use of a hydrophobic material in preparation of a polyol composition of the disclosure can modify the properties, e.g., of polyurethane polymers subsequently prepared by using the inventive polyol composition as a polyol component in conjunction with a polyisocyanate in formation of the polyurethane polymer. For example, the hydrophobic material can comprise a natural oil, a fatty acid or a fatty acid ester derived therefrom; or a mixture thereof. More specifically, the hydrophobic material can comprise a plant oil, a fatty acid or a fatty acid ester derived therefrom; or a mixture thereof. In one embodiment, the hydrophobic material can comprise an animal oil, a fatty acid or a fatty acid ester derived therefrom, and mixtures thereof. Specifically, the hydrophobic material can comprise one or more of tallow oil, tall oil fatty acid, soybean oil, coconut oil, castor oil, linseed oil, a nonedibile plant-derived oil, or an edible plant-derived oil. Alternatively, the hydrophobic material can comprise a synthetic oil, a synthetic fatty acid, or a synthetic fatty ester. Or, the hydrophobic material can be an aminated material, a hydroxylated material, or a combination thereof, such as an amine, an aminoalcohol, a hydroxyacid, or a combination thereof.

Oils can also be used in the formation of the pre-polymer composition. In one embodiment, the pre-polymer composition can comprise a hydrocarbon oil. In another aspect, the oil can be an animal oil, tallow oil, soybean oil, coconut oil, castor oil, linseed oil, a nonedibile plant-derived oil, an edible plant-derived oil, a synthetic oil, or mixtures and combinations thereof.

Optionally, when preparing a resin blend, prepolymer, or polyurethane, one or more additional ingredient can be added, such as another polyol, a solvent, a catalyst, a chain extender, a crosslinking agent, a curative, a surfactant, a blowing agent, a filler, a flame retardant, a plasticizer, a light stabilizer, a colorant, a wax, a biocide, a mineral, a micronutrient, an inhibitor, a stabilizer, an organic additive, an inorganic additive, or mixtures thereof.

In preparation of a polyol composition of the present disclosure, components can be added and the mixture further processed, e.g., by heating and distillation of monofunctional components, until favorable properties of the product are achieved. For example, a polyol composition with favorable properties for preparation of PU polymers has a relatively low free carboxylic acid content (which can be expressed as acid number, defined above). More specifically, a polyol composition suitable for preparation of a PU polymer can have an OH value of about 50 to 500 mg KOH/gm; or, can have an acid number of less than 10 mg KOH/gm, or less than 5 mg KOH/gm, or for example, less than 1 mg KOH/gm of sample; or any combination thereof. A polyol with a low acid number, such as less than 10 mg KOH/gm, or less than 5 mg KOH/gm of sample, or less than 1 mg KOH/gm, has relatively few free, un-esterified carboxylic acid groups. A polyol with a high OH value, such as about 100 to 500 mg KOH/gm, has a relatively high proportion per mass of reactive hydroxyl groups available for condensation with isocyanate groups of the polyfunctional isocyanate to yield the urethane (carbamate) groups of a resulting PU polymer. A polyol with low OH value, such as about 50 to 100 mg KOH/g, has a relatively higher average molecular weight and may provide desirable properties in some polyurethane applications. The preferred OH value will be determined by the requirements of the application.

Accordingly, the process can provide a polyol composition prepared using any combination or subcombination of the above-recited methods and variants thereof. As described below, these polyol compositions find uses in many final products, thus conferring a higher value on what has hitherto been a waste product of a chemical process.

### Resin Blend and Pre-Polymer Compositions for Forming PU Polymer Compositions

The present disclosure also provides resin blend compositions for foamed and non-foamed applications that include polyol compositions as components. Embodiments of the resin blend include a polyol prepared as described herein where the polyol contains monofunctional components including butyric acid, valeric acid, and caproic acid, such that the monofunctional components are present in the polyol in an amount from about 0.01 wt % to about 26 wt %. Additionally, the amounts of monofunctional components and multifunctional compounds discussed above with respect to the polyols apply to the resin blend and pre-polymer compositions, as well as the polyurethane binders and materials and applications discussed herein.

Further, one or more other components, such as catalysts and modifiers, known to those skilled in the art and dependent on end use can be added to the resin blend. Such components may include, in addition to catalysts for the reaction, other modifier polyols, solvents, chain extenders, crosslinking agents, curatives, surfactants, blowing agents, fillers, flame retardants, plasticizers, light stabilizers, colorants, waxes, biocides, inhibitors, stabilizers, minerals, micronutrients, or other organic or inorganic additives. A resin blend can be a composition of sufficient stability to be shipped or stored for prolonged periods, while retaining its reactivity with an intended coreactant sufficient to form a pre-polymer and polymer having properties adequate for the intended function. A resin blend can contain a coreactant, provided that the coreactant component and the polyol component of the resin blend react at a sufficiently low rate for the purpose intended.

A resin blend can comprise a polyol prepared as described herein and one or more of the aforementioned components and can exclude coreactive ingredients such as polyisocyanates. Resin blends excluding coreactive ingredients have longer shelf life than resin blends containing such ingredients and may be blended with coreactive ingredients such as isocyanate at the time of use. However, a resin bland can, in some specific circumstance under conditions where premature reaction is not an issue, also include a coreactant. Typically, however, a resin blend does not contain a coreactant until a coreactant, e.g., a polyisocyanate, suitable for preparation of a pre-polymer composition and resulting polymer, e.g., a polyurethane, is added at the time of use.

A “pre-polymer composition” refers to a composition that can be semi-liquid or flowable prior to the ultimate reaction of the prepolymer and the coreactant such as chain extender that is added at the time of fmal use. A prepolymer composition can be obtained by mixing the two mutually reactive components, i.e. polyol and polyfunctional isocyanate, in proportions such that isocyanate is in excess and allowing reaction to proceed to give an isocyanate-terminated prepolymer. The prepolymer is subsequently allowed to react with another reactive hydrogen compound (chain extender or crosslinker) and can “set up” to form a solid polyurethane or polyurea material. For example, a polyurethane-forming pre-polymer composition can include a polyol composition or a resin blend of the present disclosure, plus a polyfunctional monomer, e.g., a polyfunctional isocyanate as a coreactant, and other optional ingredients as outlined above. Before the final reaction of the prepolymer composition and the chain extender or crosslinker, the physical state of the pre-polymer composition can be liquid or quasi-liquid, having a greater or lesser viscosity depending upon specific components, or can be a malleable soft gel. As reaction occurs between the prepolymer of the present disclosure and the reactive, e.g., active hydrogen, groups of the crosslinker or chain extender, the isocyanate groups of the prepolymer can react with the active hydrogen groups of the crosslinker or chain extender to form carbamate (urethane) or urea bonds.

To the extent that modifiers and the like containing amino groups are present in the resin blend or are added as crosslinkers or chain extenders, reaction with the isocyanate groups can yield urea groups as well. As this covalent reaction proceeds, the physical state of the substance changes from the liquid or quasi-liquid state to a solid state, in which the polymeric product is present. When the pre-polymer composition solidifies into the solid polymer product, it is said that the material “sets” or “sets up.” If a solvent is present in the pre-polymer composition, the solvent can at least partially evaporate during the condensation or “setting up” process.

By this, application of a pre-polymer composition as a coating, adhesive, sealer, binder, and the like, to an object or objects, can be accomplished while the pre-polymer composition is flowable, sprayable, or spreadable, but on standing for a suitable period of time, such as minutes to hours, and at a suitable temperature, such as room temperature or higher (or in certain combinations, below room temperature), the mixture undergoes polymerization/cross-linking, and a solid, if flexible, material is produced. By “room temperature,” what is meant is a temperature in the range of about 20° C. to 25° C. Alternatively, the coating, adhesive, sealer, binder, and the like, can be applied to the object or objects by separately applying the resin blend and the coreactant, either simultaneously or sequentially, such that the pre-polymer composition is formed in situ on the surface(s) of the object(s).

It is understood that the polyurethane polymer that results can still have a tacky texture, and can still contain residues of optional solvents and the like, but a phase transition from liquid to solid has taken place. The solid material then provides the coating or sealing effect, and, if adherent to the object(s), the adhesive effect.

The liquid or quasi-liquid pre-polymer composition can be foamed by use of a blowing agent, i.e., a volatile material that liquefies and expands within the solidifying pre-polymer composition, producing bubbles in the material that are then present in the final foam structure containing the solid polymer reaction product. Foams can be adherent as well, depending upon the nature of the objects they contact, and can be used as insulation, packing, and the like. Alternatively, the foam can set up without adherence, producing solid foam blocks, sheets, packing peanuts, and the like.

A pre-polymer composition comprising a polyol composition of the present disclosure and a polyfunctional isocyanate can yield a polyurethane polymer, or a polyisocyanurate polymer, or a polymer that can include both functional groups, depending on the conditions and the ratios of reactants present in the blend. The polyurethane polymer can include predominantly carbamate groups of formula R—NH—C(═O)—O—R′, wherein R and the bonded nitrogen-carbonyl is derived from the isocyanate coreactant, and R′—O is derived from the polyol, with the understanding that R and R′ have other functional groups bonded thereto that themselves are further bonded, providing the high molecular weight polymer substance. A polyisocyanurate polymer contains triazine rings in addition to the urethane bonds, which are believed to be formed via the reaction of three of the diisocyanate molecules to yield an intermediate of formula:

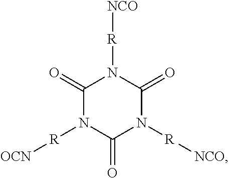

which can then react at the exocyclic isocyanate groups with polyol hydroxy groups to yield the PIR polymer, a variant of the PU polymer. Thus, PIR polymers can be more highly crosslinked, and more rigid, than some other PU polymers, although both kinds of polymers can contain domains of linear polyurethane. Various amines and polyamines can also be used as curatives, crosslinkers, or chain extenders, and thus, it should be understood that when primary or secondary amines are used as such, the urea linkages may be present in the resulting polymer. Urea linkages have the structure R—NH—C(═O)—NR′R″, wherein R and the bonded nitrogen-carbonyl is derived from the isocyanate coreactant, and —NR′R″ is derived from the primary or secondary amine, with the understanding that either R′ or R″ but not both may be H and R, R′, and R″ have other functional groups bonded thereto that themselves are further bonded, providing the high molecular weight polymer substance.

Higher relative amounts of coreactant isocyanates, such as MDI, and use of polyester polyols, such as the polyol compositions of the present disclosure, can favor formation of polyisocyanurate linking groups over carbamate linking groups.

Accordingly, the present disclosure describes and provides a pre-polymer composition for formation of a polymer, comprising a polyol of the present disclosure, a coreactant, and optionally, a catalyst and/or solvent. For example, the coreactant can be a polyfunctional isocyanate, for formation of a PU or PIR polymer.

A pre-polymer composition can include the polyester polyol of the present disclosure, a coreactant such as a diisocyanate, and optionally a catalyst for non-foamed applications such as polyurethane based coatings, binders, adhesives, sealants, and elastomers. The pre-polymer composition can include the polyol composition, a coreactant, and a catalyst for coating applications. Other components can be included; for example, a solvent can be used for coating applications. The pre-polymer composition including a polyol composition of the current disclosure can also include any one or combination of polyurethane formulation components known to those skilled in the art, such as described in the book “Polyurethanes Chemistry, Technology, and Applications by Z. Wirpsza (Ellis Horwood, 1993).

Accordingly, the present disclosure also describes and provides methods and compositions related to the polyurethane polymer, the method of preparation comprising mixing a polyol composition as described herein, or a polyol composition prepared by the method described herein, and a polyfunctional isocyanate. A polyfunctional isocyanate is an isocyanate with at least two isocyanate functional groups per molecule. For example, the polyfunctional isocyanate can comprise, or can be, monomeric methylene diphenyl diisocyanate (MDI), polymeric MDI, an aliphatic diisocyanate, a cycloaliphatic diisocyanate, an aromatic diisocyanate, a multifunctional aromatic isocyanate, an organic polyisocyanate, a modified polyisocyanate, an isocyanate-based pre-polymer, or a mixture thereof. More specifically, the polyfunctional isocyanate can include more than two isocyanate groups, on average, per molecule. Thus, the polyfunctional isocyanate can be polymeric MDI (PMDI) with average functionality of about 2.1 to about 3.3.

A catalyst can be added when mixing the polyol composition and the polyfunctional isocyanate. For example, the catalyst can comprise an amine, e.g., triethanolamine or diazobicyclooctane; or the catalyst can comprise an organometallic compound such as tetraisopropyl titanate or dibutyl tin dilaurate; or the catalyst can comprise a metal carboxylate, such as potassium acetate or potassium octoate. Various other catalysts are known in the art and can be used such as those described in “Polyurethanes Chemistry, Technology, and Applications by Z. Wirpsza (Ellis Horwood, 1993).

Depending on the use of the PU or PIR polymer, a solvent can be added when mixing the resin blend and the polyfunctional isocyanate. For example, solvent can comprise a hydrocarbon, such as toluene.

Similarly, a method of preparing a polyisocyanurate polymer can comprise mixing a resin blend prepared as described herein and MDI. The method can further comprise adding a catalyst, such as an amine like triethanolamine or diazobicyclooctane (e.g., a DABCO® series catalyst from Air Products Corp.), when mixing the resin composition and the MDI.

Examples of PU/PIR polymers made using the polyol compositions of the present disclosure are described in more detail in the Examples, below.

The present disclosure also describes foam compositions, comprising a resin blend prepared as described herein, and a polyfunctional isocyanate, with a blowing agent. The foam composition incorporating a polyester polyol resin prepared by a method described herein and can be used in rigid applications such as in appliance, spray, and other pour-in-place applications. The foam composition incorporating a polyester polyol blend resin can be used in flexible applications.

The pre-polymer composition for producing a PU or PIR polymer can also include a polyol composition or resin blend, and a coreactant such as a diisocyanate or a polyisocyanate can also include a surfactant, a catalyst, and a blowing agent for foamed applications.

The surfactant for use in foamed applications can include any surfactant known to a skilled person in the art for the purposes of making a suitable PU and/or PIR spray foam. In one embodiment, the surfactant can include silicone based surfactants, organic based surfactants, or a mixture thereof. In another embodiment, the surfactant can be present at about 0.25 to 3.0% by weight of the pre-polymer composition.

Accordingly, the present disclosure can also provide a foam composition comprising a polyurethane polymer or a polyisocyanurate polymer as described herein, and a blowing agent, and, optionally, a surfactant. The foam can comprise the polymer and can be formed by foaming a liquid or quasi-liquid pre-polymer composition that is a precursor to the polymer, the pre-polymer composition components then setting up to yield the solid foam material. The blowing agent that creates the foam in, e.g., a viscous liquid pre-polymer composition, can be any suitable volatile material. For example, the blowing agent can comprise a hydrocarbon having 3 to 7 carbon atoms, a hydrofluorocarbon, water, carbon dioxide, or a mixture thereof. More specifically, a hydrofluorocarbon blowing agent can be 1,1,1,3,3-pentafluoropropane (HFC-245fa), 1,1,1,2-tetrafluoroethane (HCF-134a), 1,1-dichloro-1-fluoroethane (HCFC 141-B), chlorodifluoromethane (HCFC R-22), 1,1,1,3,3-pentafluorobutane (HFC-365mfc), or a combination thereof. More specifically, a hydrocarbon blowing agent can be butane, n-pentane, i-pentane, cyclopentane, hexane, cyclohexane, any of their alkene analogues, or a combination thereof. The blowing agent can include two or more blowing agents (e.g., blowing agent, co-blowing agent, and the like). For example, the blowing agent can be 1,1,1,3,3-pentafluoropropane and the co-blowing agent can be water, where 1,1,1,3,3-pentafluoropropane can be about 60 to 99% by weight of the blowing agents and water can be about 1 to 40% by weight of the blowing agents. The total amount of the blowing agent(s) can be about 5 to 25% by weight or can be about 8 to 15% by weight, of the pre-polymer composition.

Thus, the present disclosure can provide a method of preparing a foam composition, comprising mixing a polyol prepare as described herein, a polyfunctional isocyanate, and a blowing agent to yield a pre-polymer composition comprising the blowing agent, which foams and sets up to yield the foam formed of the solid polymer material. The mixture can be sprayed, foamed in place, or otherwise applied in any suitable manner.

A catalyst can be used in preparing a foam composition. The catalyst can include a metal-based catalyst, amine-based catalyst, or a mixture thereof. The metal-based catalyst can include, but is not limited to, organomercury, organolead, organoferric, organotin, organobismuth, organozinc catalysts (e.g., stannous octoate and dibutyltin dilaurate), and a combination thereof. The amine-based catalyst can include, but is not limited to, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropylamine, dimethyl-benzyl amine, triethanolamine, triisopropanolamine, or any combination thereof. The catalyst can be present at about 0.001 to 10% by weight of the pre-polymer composition.

In various uses, a pre-polymer composition comprising the polyol and a coreactant, such as a polyfunctional isocyanate, can include a solvent, e.g., for coating uses, adhesive uses, binder uses, and the like. In one embodiment, a solvent can be one or more substances that are liquid at temperature of use and capable of dissolving the pre-polymer composition. Solvents may be non-reactive solvents that do not react with isocyanate, or reactive solvents that react with isocyanate and become incorporated into the polyurethane. Use of reactive solvents can help reduce emissions of volatile organic compounds (VOCs) during use of the pre-polymer composition. Suitable solvents may include but are not limited to toluene, xylene and other aromatic solvents including higher-boiling mixtures such as Aromatic 150 (e.g., Solvesso 150® of Exxon Mobil Chemical), limonene and other unsaturated hydrocarbons, ester solvents such as methyl acetate, ethyl acetate, propyl acetate, butyl acetate, t-butyl acetate, methyl glycolate, ethyl glycolate, propyl glycolate, butyl glycolate methyl lactate, ethyl lactate, propyl lactate, butyl lactate, dimethyl succinate, dimethyl glutarate, dimethyl adipate, diisobutyl succinate, diisobutyl glutarate, diisobutyl adipate, methyl 6-hydroxycaproate, methyl 5-hydroxyvalerate, methyl 4-hydroxybutyrate, methyl levulinate, ethyl levulinate, butyrolactone, valerolactone, 3-ethoxy ethyl propionate (EEP), esters derived from natural fats and oils such as methyl soyate, esters derived from other bio-based materials such as isosorbide esters or bio-succinic acid esters, carbonates such as dimethyl carbonate or propylene carbonate, ethers such as tetrahydrofuran and dimethyl isosorbide, ketones such as acetone, 2-butanone, methyl isobutyl ketone, diisobutyl ketone, and isophorone, amides such as dimethyl formamide (DMF) or dimethyl acetamide (DMAC), glycol ethers such as ethylene glycol butyl ether (EB), diethylene glycol butyl ether, and tripropylene glycol methyl ether, glycol esters such as ethylene glycol diacetate and propylene glycol diacetate, glycol ether esters such as propylene glycol methyl ether acetate, propylene glycol methyl ether propionate, dipropylene glycol methyl ether acetate, ethylene glycol butyl ether acetate, diethylene glycol butyl ether acetate, halogenated solvents such as methylene chloride and p-chlorobenzotrifluoride, and others including dimethyl sulfoxide (DMSO), N-methyl pyrrolidone (NMP), etc,

In the United States, certain solvents may be preferred over others because they are considered to be VOC exempt or because they have low photochemical reactivity. VOC exempt solvents are listed in the United States Code of Federal Regulations, Title 40, Part 51.100, and this list as it exists on the date of filing of the present disclosure with the USPTO is incorporated by reference. Such solvents include, among others, acetone, methyl acetate, dimethyl carbonate, methylene chloride, t-butyl acetate, propylene carbonate, and p-chlorobenzotrifluoride.

Low photochemical reactivity refers to the tendency of a solvent to participate in photochemical reactions that contribute to ground-level ozone and “smog.” One measure of photochemical reactivity is maximum incremental reactivity (MIR) as described in work by Professor William P. L. Carter and others; see, for example, “Development of ozone reactivity scales for volatile organic compounds” by William P. L. Carter published in the Journal of the Air and Waste Management Association, volume 44, pages 881-899, Jan. 20, 1994, which is incorporated herein by reference. Dimethyl succinate and dimethyl glutarate are two examples of solvents having desirable low MIR values of 0.23 and 0.42 respectively.

The pre-polymer composition, e.g., for foamed applications, can be prepared by various methods. For example, resin blend compositions can be added to a blend tank and mixed under ambient conditions with the coreactant and catalyst, if used, and, if the blend tank is pressure rated, a blowing agent may be added last and all the compositions mixed for a period of time until a homogenous mixture is produced. When the composition is dispensed and the pressure released, foaming of the pre-polymer composition occurs to provide a foamed polymer upon set-up.

As mentioned above, embodiments of the present disclosure include compositions for coatings, adhesives, sealants, elastomers, and binders that include a reaction product of an inventive polyol composition or resin blend comprising the polyol, with a polyfunctional isocyanate. Embodiments of the present disclosure also include pour-in-place foam compositions, spray foam compositions, polyisocyanurate foam compositions that include a reaction product of the polyol composition with a polyfunctional isocyanate. The polyol composition can include any of the polyol compositions described herein. For example, the polyfunctional isocyanate can include any isocyanate with an average functionality of at least two that can be used to make a suitable polyurethane and/or polyisocyanurate foam.

As noted above, the present disclosure can provide polymer foams including polyurethane and/or polyisocyanurate foams. The PU and/or PIR foams can include an aliphatic polyester polyol composition, a coreactant polyisocyanate, a catalyst, a surfactant, and a blowing agent. The aliphatic polyester polyol composition can include any of the aliphatic polyester polyol compositions described herein. In addition, the catalyst, the surfactant, and the blowing agent can be any of the catalyst, the surfactant, and the blowing agent described herein.

The pre-polymer composition can be used to produce a polyurethane and/or a polyisocyanurate foam for spray or other types of application with an NCO index ranging from about 100 to 400. In one embodiment, the aliphatic polyester polyol blend composition for this use can have an average functionality of at least about 1.5 and an overall hydroxyl value of at least about 120.

The PU and/or PIR foam can be produced at various volume ratios of polyol composition and polyisocyanate to obtain a certain Isocyanate Index. The ratios are normally referred to as A:B where “A” (or A-side component) is the polyisocyanate and “B” (or B-side component) is the polyol composition, according to common usage in the USA, although A-side and B-side may have other meanings in other parts of the world (e.g., in Europe). In an embodiment, the ratio can be about 1:1 to 4:1.

The A-side component can be a polyisocyanate of the formulations disclosed herein, which can incorporate polymeric MDI (PMDI). As those skilled in the art know, Mondur® MR Lite from Bayer Corporation and Rubinate® M from Huntsman Corporation are typically used. However, it is not intended the A-side component be limited to those specifically illustrated herein. For example, the A-side component of the formulations of the present disclosure can be selected from organic polyisocyanates, modified polyisocyanates, isocyanate-based pre-polymers, and mixtures thereof. Such choices can also include aliphatic and cycloaliphatic isocyanates, but aromatic and especially multifunctional aromatic isocyanates are particularly useful.

The present disclosure can also provide a sealant, adhesive, or binder, comprising a polyurethane polymer of the disclosure, or prepared by the method of the disclosure, or a polyisocyanurate polymer of the disclosure or prepared by the method of the disclosure.

### Foam Padding

In accordance with much of the chemistry and methodology described herein, a method of manufacturing foam padding can comprise obtaining a pre-polymer composition as described herein, mixing the pre-polymer composition with a recycled foam; molding the recycled foam and the pre-polymer composition into a shape; and curing the pre-polymer composition. As discussed herein, the pre-polymer composition can comprise a polyol and a polyfunctional monomer, where the polyol is prepared by heating a byproduct mixture containing a non-volatile residue of a cyclohexane oxidation reaction product to remove monofunctional components to a concentration of about 0.01 wt % to about 26 wt % and water by distillation, and wherein the polyol is further prepared by reacting the non-volatile residue of a cyclohexane oxidation reaction product with one or more polyhydroxy compounds. Generally, the recycled foam can be any type of polymeric foam material. In one embodiment, the recycled foam can comprise polyurethane polymer.

The present steps of preparing the recycled foam, mixing, molding, and curing can be accomplished by any of a number of processes known in the art. For example, such processing is further discussed in U.S. Publication No. 2006/0251881, which is incorporated by reference in its entirety.

Preparing the recycled foam generally involves reducing the size of the recycled foam for subsequent processing into foam padding. Such reduction can be accomplished by any means in the art including without limitation chopping, shredding, tearing, ripping, etc. In one embodiment, preparing includes reducing the recycled foam in size such that the recycled foam has a width, length, and height from about ¼ inch to about ¾ inch.

Generally, curing involves the polymerization of the polyol and polyfunctional monomers in the pre-polymer composition to form a polyurethane polymer. As such, in one embodiment, curing includes polymerizing the pre-polymer composition resulting in a solid foam padding material. The solid foam padding material can be molded into a block, cylinder (e.g. log), or other shape for subsequent processing into a foam pad. In one embodiment, the method can further comprise adhering a barrier film to the surface of the foam padding. Such processing and composition can include those described in U.S. Pat. No. 6,872,445, which is incorporated by reference in its entirety. In one embodiment, the barrier can be formed from vulcanized silicone rubber, silicone polymer, polyurethanes, polyether/polyester, polyether/amides, polyvinyl alcohol, copolymers thereof, or blends thereof. Additionally, the foam padding can further comprise an adhesive material that bonds the barrier film to the foam padding.

In addition to the present method, a foam padding can comprise recycled foam and a polyurethane binder polymerized from a polyol and a polyfunctional monomer, the polyurethane binder containing monofunctional components can include butyric acid, valeric acid, and caproic acid, and the monofunctional components present in the polyurethane binder can be present at from about 0.01 wt % to about 26 wt % of the polyol weight.

As discussed herein, the polyurethane binder can include butyric acid present in an amount from about 0.01 wt % to about 5 wt %, valeric acid present in an amount from about 0.05 wt % to about 15 wt %, and caproic acid present in an amount from about 0.01 wt % to about 6 wt In one aspect, the butyric acid can be present in an amount from about 0.2 wt % to about 0.8 wt %, the valeric acid can be present in an amount from about 2 wt % to about 7 wt %, and the caproic acid can be present in an amount from about 1.5 wt % to about 3.5 wt %. All percentages are expressed relative to weight of the polyol used in the polyurethane binder.

In one embodiment, the polyurethane binder can contain levulinic acid and multifunctional compounds including: hydroxycaproic acid and adipic acid. In one aspect, the levulinic acid can be present in an amount from about 0.01 wt % to about 5 wt %, the hydroxycaproic acid can be present in an amount from about 3 wt % to about 45 wt %, and the adipic acid can be present in an amount from about 3 wt % to about 35 wt %. All percentages are expressed relative to weight of the polyol used in the polyurethane binder.

As discussed above, the foam padding can further comprise a barrier film and, in one aspect, an adhesive material that bonds the barrier film to the foam padding. Generally, the present foam padding can include amounts of binder and recycled foam according to the desired application and strength characteristics desired. In one embodiment, the recycled foam can be present in the padding in an amount of about 80 wt % to 99 wt %, for example, from about 85 wt % to 95 wt %, for example, 87 to 93 wt %. Additionally, the polyurethane binder can be present in the padding in an amount of about 1 wt % to 20 wt %, for example, from about 5 wt % to 15 wt %, for example, 8 to 12 wt %. Further, the recycled foam and polyurethane binder can be present in the padding at a ratio ranging from about 4:1 to about 99:1, for example, about 6:1 to about 19:1, by weight, for example, 7:1 to 15:1 by weight.

### Fiber-Reinforced Composite Material

In addition to the foam padding applications, the present resin blends, pre-polymer compositions, polyols, and polyurethane polymers can be used in the manufacturing of fiber-reinforced composite materials. In one embodiment, a method of manufacturing a fiber-reinforced composite material can comprise preparing a pre-polymer composition; contacting a fiber substance with the pre-polymer composition; and curing the pre-polymer composition. As discussed herein, the pre-polymer composition can comprise a polyol and a polyfunctional monomer, where the polyol is prepared by heating a byproduct mixture containing a non-volatile residue of a cyclohexane oxidation reaction product to remove monofunctional components to a concentration of about 0.01 wt % to about 26 wt % and water by distillation, and where the polyol is further prepared by reacting the non-volatile residue of a cyclohexane oxidation reaction product with one or more polyhydroxy compounds. The present method can include the processing steps and compositions as discussed herein.

A fiber-reinforced composite material can comprise a fiber substance and a polyurethane binder polymerized from a polyol and a polyfunctional monomer, the polyurethane binder containing monofunctional components including butyric acid, valeric acid, and caproic acid, the monofunctional components present in the polyurethane binder in an amount from about 0.01 wt % to about 26 wt % based on weight of contained polyol. The present materials can include those compositional elements as discussed herein.

Generally, the present fiber substance can be any type of fiber substance. In one embodiment, the fiber substance can be cellulosic. In another aspect, the cellulosic substance comprises wood fibers.

Generally, the present fiber-reinforced composite material can include amounts of binder and fiber according to desired application and strength characteristics. In one embodiment, the polyurethane binder can be present in the fiber-reinforced composite material in an amount of about 1 wt % to 50 wt %, for example, 5 wt % to about 20 wt %, for example, 7 wt % to 15 wt %. In another embodiment, the fiber substance can be present in the fiber-reinforced composite material in an amount of about 50 wt % to 99 wt %, for example, about 80 wt % to about 95 wt %, for example, 88 wt % to 93 wt %. Additionally, the fiber substance and polyurethane binder can be present in the fiber-reinforced composite material at a ratio ranging from 1:1 to 99:1, for example, about 4:1 to about 19:1, for example 7:1 to 15.1 by weight.

### EXAMPLES

### Analysis of NVR Polyols

As noted elsewhere herein, NVR contains mono- and poly-functional molecules bearing alcohol and carboxylic acid functional groups that can react with each other through well-known condensation reactions to form ester linkages. When two or more such monomeric molecules link by formation of ester linkages, the resulting larger molecule is called an ester oligomer. When at least one of the monomeric molecules is polyfunctional, it is possible to form ester oligomers by linking 3 or more monomeric molecules by ester linkages. Ester oligomers, particularly higher molecular weight oligomers, are not amenable to analysis by gas chromatography (GC) because they are not sufficiently volatile or stable. Consequently, GC analysis of NVR “as is” may give an incomplete picture of composition. For example, some of the adipic acid contained in NVR is present as free adipic acid, but some is also present bound in ester oligomers formed by reaction of adipic acid with hydroxyl compounds present in NVR. One example of such an ester oligomer would be the ester oligomer formed from adipic acid and 6-hydroxycaproic acid. NVR may be derivatized before analysis by treatment with common derivatization agents such as bis(trifluoromethyl)trifluoroacetamide (BSTFA), but even after such treatment, direct analysis of NVR reveals only the amount of free adipic acid, which represents only a fraction of the total adipic acid contained in free and bound or ester oligomeric states.

It has been found to be useful to analyze NVR by a methanolysis method, wherein NVR is allowed to react with excess methanol in the presence of an esterification catalyst such as sulfuric acid. Transesterification of ester oligomers with excess methanol forms monomeric methyl esters that are easily analyzed by GC. The advantage of this analysis method is that it provides an analysis of the contained monomeric species whether they are present as monomers or ester oligomers.

The methanolysis analysis is done by refluxing ˜1 g sample and 0.125 g suberic acid internal standard with 10 g of 10% sulfuric acid in methanol. The resulting mixture is diluted with 50 mL deionized water and extracted with three 20-mL portions of methylene chloride. The methylene chloride extracts are analyzed by gas chromatography on an HP-FFAP column using a method that was calibrated using authentic materials of known composition. Table 4, below, summarizes analytical results from several different samples of NVR obtained using the methanolysis method. The table also shows “free adipic acid” as determined by BSTFA derivatization and GC analysis, for comparison with the “total adipic acid” as determined by the methanolysis method.

The exact composition of cyclohexane oxidation byproducts of the NVR may vary, but the characteristic difunctional components adipic acid and 6-hydroxycaproic acid are both always present in free and/or bound (i.e. esterified) states. Characteristic monofunctional components include but are not limited to butyric acid, valeric acid, and caproic acid. These monofunctional components can be at least partly removed to form a refined mixture before and/or during formation of the polyol of the present disclosure is completed.

TABLE 1
Partial Composition of NVR

| Component | NVR-A | NVR-B | NVR-C | NVR-D | NVR-E |
|---|---|---|---|---|---|
| Water | 22.0 | 27.8 | 23.6 | 19.6 | 23.6 |
| Total butyric acid | 1.6 | 0.5 | 2.0 | 1.0 | 1.7 |
| Total valeric acid | 11.0 | 4.6 | 11.4 | 7.4 | 11.7 |
| Total caproic acid | 4.0 | 2.5 | 3.6 | 3.5 | 4.4 |
| Total succinic acid | 0.5 | 0.6 | 0.4 | 0.4 | 0.4 |
| Total glutaric acid | 2.1 | 1.5 | 1.5 | 1.4 | 1.9 |
| Total adipic acid | 12.4 | 15.3 | 9.3 | 12.1 | 11.3 |
| (Free adipic acid) | 3.1 | 3.9 | 2.7 | 3.0 | 2.9 |
| Total HCA* | 14.5 | 22.0 | 16.0 | 19.1 | 12.0 |

*HCA = hydroxycaproic acid

### Procedures for Applying Coating

In general, a coating comprises a Part A and a Part B capable of reacting with each other to form a polyurethane polymer. Part B may be a pre-polymer composition comprising at least one polyol and optionally other components as described above. In particular, the other components may include other isocyanate-reactive compounds such as chain extenders or crosslinkers, one or more catalysts, and one or more solvents. Part A comprises at least one isocyanate and optionally one or more solvents. Relative amounts of reactants are calculated to produce polyurethane with the desired isocyanate index, where isocyanate index is calculated as the molar ratio of isocyanate to isocyanate-reactive groups. As described above, isocyanate index may be expressed as a percentage, where 100 indicates a molar ratio of isocyanate to isocyanate-reactive groups of 100%. Isocyanate index may also be expressed as a simple ratio rather than as a percentage and the two expressions are equivalent: for example, an isocyanate index of 1 is equivalent to index of 100% and indicates equal moles of isocyanate and isocyanate-reactive groups while isocyanate index 1.05 is equivalent to 105% and indicates a 5% molar excess of isocyanate over isocyanate-reactive groups.

### Polyol Example 1

A polyol with hydroxyl number 168 is prepared using NVR-D and diethylene glycol as follows.

A 3-liter round-bottom flask is charged with 565 g NVR-D (see Table 1) and 225 g diethylene glycol. The flask is fitted with a distillation takeoff, condenser, and distillate receiver, a vacuum connection, magnetic stirrer, and a dip-tube (sparger) to admit nitrogen below the surface of the liquid. The mixture is heated and sparged with nitrogen while pressure is reduced to ˜300 mm Hg. Distillate is collected in the distillate receiver. When no more distillate is seen coming overhead, vacuum is broken with nitrogen and the mixture allowed to cool to <100° C.

Collected distillate is removed and found to weigh 153 g. Analysis of the distillate shows that it contains monofunctional components including cyclohexanol, butyric acid, valeric acid, and caproic acid but desirable difunctional species including adipic acid and 6-hydroxycaproic acid are not detected. The nitrogen sparger is removed, 0.15 g titanium tetraisopropoxide added, and the mixture heated under vacuum. Temperature is increased to 196° C. and pressure reduced to 142 mm over ˜4 hour. Pressure is reduced further to ˜42 mm Hg over the course of an additional 2.6 hours, while temperature is maintained in the range 196-200° C. Heat is removed and the mixture allowed to cool under nitrogen.

The reaction mixture is analyzed for hydroxyl number. Hydroxyl number is found to be 158 mg KOH/g. Diethylene glycol (4.56 g) is added and the reaction mixture heated to 180° C. for 1 hour to re-equilibrate the polyol with the added diethylene glycol. The product polyol has hydroxyl number 168 mg KOH/g, viscosity of 324 cSt at 23° C., and weighs 464 g.

The NVR-D starting material and polyol product are both analyzed using the methanolysis method described above. The weight ratio of valeric acid to adipic acid is found to be 0.61 in the NVR-D feed and only 0.32 in the polyol product, showing that the polyol product contains only 52% of the monofunctional valeric acid, relative to adipic acid, as is present in the NVR-D starting material. As noted above, analysis of the condensate shows that the monofunctional components were at least partly removed with the condensate, explaining the reduced amount found in the polyol product. The weight ratio of adipic acid to 6-hydroxycaproic acid is 0.63 in the NVR-D starting material and 0.66 in the polyol product, showing that the relative amounts of those two desirable difunctional molecules is essentially unchanged by the polyol preparation.

### Polyol Example 2

A polyol with hydroxyl number 168 is prepared using NVR-E, terephthalic acid, and diethylene glycol as follows.

A 500-mL round-bottom flask is charged with 113 g NVR-E (See Table 1) and 13.5 g terephthalic acid. The flask is fitted with a distillation takeoff, condenser and distillate receiver, a vacuum connection, magnetic stirrer, and a dip-tube (sparger) to admit nitrogen below the surface of the liquid. The mixture is heated to 154° C. and sparged with nitrogen while pressure is reduced to ˜143 mm Hg. Distillate is collected in the distillate receiver. When no more distillate is seen coming overhead, vacuum is broken with nitrogen. The mixture is allowed to cool to 91° C., then 0.02 g titanium tetraisopropoxide is added. The mixture is heated to 159° C. and sparged with nitrogen while pressure is reduced to 148 mm Hg. When no more distillate is seen coming overhead, vacuum is broken with nitrogen. The distillate is removed and found to weigh 32.4 g.

Diethylene glycol (70 g) is added and the reaction mixture heated to 156° C. and sparged with nitrogen while pressure is reduced to 283 mm Hg. After 3 hours, 0.02 g additional titanium tetraisopropoxide is added, the nitrogen sparge is removed, and the mixture heated under vacuum. Temperature is maintained in the range 174-208° C. while pressure is reduced to 41 mm Hg. After 7.5 hours at these conditions, 57.9 g distillate has been collected. The reaction mixture weighs 104.8 g and analysis shows acid number to be 0.21 mg KOH/g and hydroxyl number to be 131 mg KOH/g. Diethylene glycol (4.23 g) is added and the reaction mixture heated to 180° C. for 1 hour to equilibrate. Heat is removed and the mixture allowed to cool under nitrogen. Final product weight is 109.1 g, acid number is 0.80 mg KOH/g, hydroxyl number is 168 mg KOH/g, and viscosity is 947 cSt at 23° C.

The NVR-E starting material and polyol product are both analyzed using the methanolysis method described above. The weight ratio of valeric acid to adipic acid is found to be 1.04 in the NVR-E feed and only 0.53 in the polyol product, showing that the polyol product contains only 51% of the monofunctional valeric acid, relative to adipic acid, as is present in the NVR-E starting material.

### Polyol Example 3

A polyol with hydroxyl number 168 is prepared using NVR-D and neopentyl glycol as follows.

A 500-mL round-bottom flask is charged with 113 g NVR-D (see Table 1) and 68.3 g neopentyl glycol. The flask is fitted with a distillation takeoff, condenser, and distillate receiver, a vacuum connection, magnetic stirrer, and a dip-tube (sparger) to admit nitrogen below the surface of the liquid. The mixture is heated to 151° C. and sparged with nitrogen while pressure is reduced to 298 mm Hg. Distillate is collected in the distillate receiver. When no more distillate is seen coming overhead, vacuum is broken with nitrogen and the mixture allowed to cool to <100° C. The weight of distillate collected is 32.9 g. The nitrogen sparger is removed, 0.03 g titanium tetraisopropoxide added, and the mixture heated and maintained in the range 173-202° C. while pressure is reduced to 40 mm Hg. Heat is removed and the mixture allowed to cool under nitrogen.

The reaction mixture is analyzed for acid number and hydroxyl number. Acid number is found to be 0.41 mg KOH/g. Hydroxyl number is found to be 142 mg KOH/g. Neopentyl glycol (2.50 g) is added and the reaction mixture heated to 180° C. for 1 hour to re-equilibrate the polyol with the added neopentyl glycol. The product polyol has acid number 0.68 mg KOH/g, hydroxyl number 167 mg KOH/g, viscosity of 667 cSt at 23° C., and weighs 89.6 g.

The NVR-D starting material and polyol product are both analyzed using the methanolysis method described above. The weight ratio of valeric acid to adipic acid is found to be 0.61 in the NVR-D feed and only 0.33 in the polyol product, showing that the polyol product contains only 54% of the monofunctional valeric acid, relative to adipic acid, as is present in the NVR-D starting material.

### Polyol Example 4

A polyol with hydroxyl number 169 is prepared using NVR-D, terephthalic acid, and diethylene glycol as follows.

A 2 L round-bottom flask is charged with 508.5 g NVR-D (see Table 1) and 60.75 g terephthalic acid. The flask is fitted with a distillation takeoff, condenser and distillate receiver, a vacuum connection, magnetic stirrer, a dip-tube (sparger) to admit nitrogen below the surface of the liquid. The mixture is heated and sparged with nitrogen while pressure is reduced to ˜150 mm Hg. Water and low boiling components of NVR distill overhead and are collected in the distillate receiver. When no more distillate is seen coming overhead, vacuum is broken with nitrogen, the mixture is allowed to cool to 118° C., and 0.1 g titanium tetraisopropoxide is added. The reaction mixture is sparged with nitrogen and heated to 160° C. while pressure is reduced to 300 mm Hg. When no more distillate is seen coming over, the vacuum is broken with nitrogen and the mixture is allowed to cool to 69° C. The accumulated distillate is drained from the distillate receiver and found to weigh 143.1 g.

Analysis of the distillate shows that it contains monofunctional components including cyclohexanol, butyric acid, valeric acid, and caproic acid but desirable difunctional species including adipic acid and 6-hydroxycaproic acid are not detected. Diethylene glycol (315 g) is added to the reaction mixture. The reaction mixture is sparged with nitrogen and heated to 160° C. while pressure is reduced to 300 mm Hg. After 3 hours, the nitrogen sparge is removed and 0.1 g titanium tetraisopropoxide added. The reaction mixture is heated to 200° C. while pressure is reduced to 150 mm Hg. After 1 hour, pressure is reduced to 40 mm Hg and held for 4.5 hours. Heat is removed and the mixture allowed to cool under nitrogen.

The reaction mixture is analyzed for hydroxyl number. Hydroxyl number is found to be 148 mg KOH/g. Diethylene glycol (10.6 g) is added and the reaction mixture heated to 180° C. for 1 hour to re-equilibrate the polyol with the added diethylene glycol. The product polyol weighs 515 g and has acid number 0.43 mg KOH/g, hydroxyl number 169 mg KOH/g, and viscosity of 773 cSt at 23° C.

The NVR-D starting material and polyol product are both analyzed using the methanolysis method described above. The weight ratio of valeric acid to adipic acid is found to be 0.61 in the NVR-D feed and only 0.31 in the polyol product, showing that the polyol product contains only 51% of the monofunctional valeric acid, relative to adipic acid, as is present in the NVR-D starting material. As noted above, analysis of the condensate shows that the monofunctional components were at least partly removed with the condensate, explaining the reduced amount found in the polyol product.

### Polyol Example 5

A polyol with hydroxyl number 188 is prepared using NVR-D, glycerine, and diethylene glycol as follows.

A 500 mL round-bottom flask is charged with 113 g NVR-D (see Table). The flask is fitted with a distillation takeoff, condenser, and distillate receiver, a vacuum connection, magnetic stirrer, and a dip-tube (sparger) to admit nitrogen below the surface of the liquid. The mixture is sparged with nitrogen while pressure is reduced to ˜300 mm Hg and the contents heated to 150° C. Distillate is collected in the distillate receiver. After ˜4.5 hours, no more distillate is seen coming overhead, vacuum is broken with nitrogen and the mixture allowed to cool. The collected distillate is removed and found to weigh 30.2 g. The nitrogen sparger is removed, 0.3 g titanium tetraisopropoxide, 10.0 g glycerine, and 28 g diethylene glycol are added, and the mixture is heated to 185° C. while pressure is reduced to 40 mm Hg. After 7 hours, the mixture is cooled. Acid number is found to be 1.76 mg KOH/g. About 0.03 g titanium tetraisopropoxide is added and temperature is increased to 200° C. while pressure reduced to 40 mm Hg. After 1 hour, acid number is found to be 0.90 mg KOH/g and hydroxyl number is 223 mg KOH/g. The collected distillate is removed and found to weigh 20.3 g.

The reaction mixture is again heated and maintained at 200-212° C. and 40 mm Hg until an additional 6.7 g distillate was collected. Heat is removed and the mixture allowed to cool under nitrogen. The product is found to weigh 88.6 g and has acid number 0.25 mg KOH/g, hydroxyl number 188 mg KOH/g, and viscosity 725 cSt at 23° C.

The NVR-D starting material and polyol product are both analyzed using the methanolysis method described above. The weight ratio of valeric acid to adipic acid is found to be 0.61 in the NVR-D feed and only 0.38 in the polyol product, showing that the polyol product contains only 62% of the monofunctional valeric acid, relative to adipic acid, as is present in the NVR-D starting material.

### Polyol Example 6

A polyol with hydroxyl number 163 is prepared using NVR-E, terephthalic acid, and diethylene glycol as follows.

A 500-mL round-bottom flask is charged with 113 g NVR-E (See Table) and 27 g terephthalic acid. The flask is fitted with a distillation takeoff, condenser and distillate receiver, a vacuum connection, magnetic stirrer, and a dip-tube (sparger) to admit nitrogen below the surface of the liquid. The mixture is heated to 154° C. and sparged with nitrogen while pressure is reduced to ˜156 mm Hg. Distillate is collected in the distillate receiver. When no more distillate is seen coming overhead, vacuum is broken with nitrogen. The mixture is allowed to cool to 122° C., then 0.02 g titanium tetraisopropoxide is added. The mixture is heated to 154° C. and sparged with nitrogen while pressure is reduced to 153 mm Hg. When no more distillate is seen coming overhead, vacuum is broken with nitrogen. Diethylene glycol (70 g) is added and the reaction mixture heated to 150° C. and sparged with nitrogen while pressure is reduced to 295 mm Hg. After 4 hours, the mixture is allowed to cool. The distillate is removed and found to weigh 33.2 g. An additional 0.02 g additional titanium tetraisopropoxide is added, the nitrogen sparge is removed, and the mixture heated under vacuum. Temperature is maintained in the range 184-202° C. while pressure is reduced to 40 mm Hg. After 6.5 hours, 36 g distillate has been collected. The reaction mixture weighs 138.8 g and analysis shows acid number to be 0.53 mg KOH/g, hydroxyl number to be 163 mg KOH/g, and viscosity to be 1181 cSt at 23° C.

The NVR-E starting material and polyol product are both analyzed using the methanolysis method described above. The weight ratio of valeric acid to adipic acid is found to be 1.04 in the NVR-E feed and only 0.69 in the polyol product, showing that the polyol product contains only 66% of the monofunctional valeric acid, relative to adipic acid, as is present in the NVR-E starting material.

### Polyols for Use in Wood-Binding Applications

The use of polyurethane binders in the preparation of synthetic board from cellulosic and/or lignocellulosic material has been described in the literature, including U.S. Pat. Nos. 4,609,513, 4,752,637, 4,833,182, 4,898,776, incorporated herein by reference in their entireties.

Polyols from the byproducts of cyclohexane oxidation are used to prepare polyurethane based binder for use in the preparation of a synthetic board from cellulosic and/or lignocellulosic materials.

A polyol can be prepared from the following ingredients in the indicated proportions, having OH values ranging from 100 to 400:

### Example 7

### Preparation of Polyol for Use in Wood-Binding and Foam Padding Applications

### Ingredients*

### Quantity

| | |
|---|---|
| Byproducts from cyclohexane oxidation process as | 60-70% |
| described above | |
| Diethylene glycol | 30-40% |
| Catalyst | |

### Procedure:

840 grams of predried byproduct as described herein from the cyclohexane oxidation process and 420 grams of diethylene glycol are charged to a 2-liter, 3-necked, round bottom flask equipped with a stirrer, thermometer and a vigreaux column. A titanate based catalyst is added at 150° C. and the ingredients are heated to 235° C. until all 99.5% of the theoretical water is removed, and the following properties are achieved:

Acid Number <2 mg KOH/gram sample
Hydroxyl values between 150-180 mg KOH/gram sample

### Viscosity <1000 cps at 25° C.

### Example 8

### Polyurethane Binder Composition

The polyurethane binder consists of the polyol blend reacted with polyisocyanate. The polyol blend can consist of the polyol listed above, aromatic polyester polyols, other polyethers, polyurethane catalyst, and a surfactant. The polyisocyanate of the binder system is any organic polyisocyanate compound with at least 2 active isocyanate groups per molecule or mixtures of such compounds.

### Binder Composition:

| | |
|---|---|
| Polyol Blend | 10-50% |
| Polyol = | 50-100% |
| Aromatic polyester polyols = | 0-50% |
| Other polyethers = | 0-50% |
| Surfactant = | 0-5% |
| Polyurethane catalyst = | 0-5% |
| Polyisocyanate | 50-90% |

### Example 9

### Wood-Binding Process Using Polyurethane Binder with Polyols

Wood fibers are treated sequentially with 1 wt % of the polyol blend described above followed by 3 wt % of polyisocyanate such as Rubinate® M. The treated furnish is compression molded at about 500 psi pressure and temperature of about 350° F. between untreated steel plattens. The operation is repeated 40-50 times and then terminated with the fiberboards still releasing without sticking at the end. Preparation of fiberboard can be done in accordance with the methods described in U.S. Pat. No. 4,609,513, which is incorporated by reference in its entirety.

### Example 10

### Foam Padding Process Using Polyurethane Binder with Polyols

A prepolymer is prepared using the polyol of Example 1: A mixture is prepared by combining 38.5 parts of PMDI (equivalent weight 135), 31.5 g polyol of Example 1, and 30 g Sundex 840 oil. The mixture is agitated and heated at 80° C. for 6 hours. The resulting prepolymer is found to have isocyanate content of 8% NCO by weight and viscosity of 2000 cSt.

Recycled foam is prepared by cutting the foam into pieces with sizes ranging from ¼ inch to ¼ inch. The chopped foam is coated with the pre-polymer composition described above in the ratio of 1 part prepolymer to 10 parts chopped foam. The coated recycled foam is compressed, based on its initial weight, steamed and dried to obtain a rebounded foam with density 6.6 lb/cubic foot.

### Example 11

### Binders for Rebond-Foam Carpet Pad

Rebonded flexible polyurethane foam (RFPUR) is known and can be used in a variety of applications such as mats, flooring, and other synthetic surfaces, including carpet underlayment. The basic process of making RFPUR is well known and is described in patents and other publications.¹ ¹ (a) Polyurethanes—Chemistry, Technology, and Applications, Z. Wirpsza, translated by A. Skup, especially chapter 18, Ellis Horwood, Ltd (1993) ISBN: 0-13-683186-9. (b) Polyurethane Handbook, G. Oertel (editor), Section 5.1.1.5., Macmillan Publishing Co. Inc. (1985) ISBN: 0-02-948920-2

RFPUR is typically manufactured using scrap from production of flexible polyurethane foam. The scrap is first reduced in size by chopping or other appropriate means to obtain pieces of the desired size, commonly ˜1-1.5 cm diameter but other sizes may also be used. The pieces are coated with 10-30% by weight of a polyurethane prepolymer, placed in a suitable mold, compressed to the desired density, and cured using water and heat. A common and efficient technique for curing is to introduce 110-130° C. steam into the mass. After curing, the block of RFPUR is demolded, set aside to post-react and dry, then cut into the desired final shape, such as sheets for carpet underlayment.

Prepolymers used in RFPUR are prepared by mixing a polyol with a controlled excess of a polyisocyanate and allowing them to react to form a prepolymer. Inexpensive process oil is typically added as a diluent to reduce viscosity and cost of the prepolymer. A typical prepolymer made using polypropylene glycol (see below) typically contains ˜30% process oil and ˜8-12% residual isocyanate (% NCO).

The polyisocyanate may be any type of isocyanate with more than 1 isocyanate group per molecule, on average. Common polyisocyanates include toluene diisocyanate, methylene diphenyl diisocyanate (MDI), or “polymeric” MDI (PMDI), however it can be contemplated to use any isocyanate with more than 1 isocyanate group per molecule on average. PMDI is often preferred because it is relatively inexpensive, has average functionality greater than 2, has low volatility so that it presents less hazard in handling, and is readily available from a number of commercial suppliers.

The process oil may be any aromatic or non-aromatic, natural or synthetic oil that is non-reactive and compatible with the prepolymer formulation. Examples include petrochemical-based products such as naphthenic oils, paraffinic oils, Group I, II, and III lubricant base stocks, and various other mineral oils, and synthetic oils such as poly alpha olefin, carboxylic ester, phosphate ester, silicone, and halogenated oils. Other examples include natural oils such as various plant-derived oils. Inexpensive naphthenic process oils such as SUNDEX 840 are widely used.

Polyols for use in RFPUR may in theory be any polyol with, on average, more than one hydroxyl group per molecule that is reactive toward the polyisocyanate. Commonly used polyols include polyether polyols, in particular poly(propylene glycol) (PPG) polyols. Polyether polyols are relatively nonpolar, inexpensive, and have excellent compatibility with naphthenic process oils like SUNDEX 840.

Polyester polyols may also be used and can be based on natural or synthetic feedstocks, including natural, plant-derived oils or petrochemical feedstocks. Combinations of natural and petrochemical materials may be used. Plant-derived polyols may include triglycerides such as castor oil that have inherent hydroxyl functionality as well as polyols obtained by functionalizing common vegetable oils like soybean oil, corn oil, canola oil and the like. Petrochemical-derived polyester polyols include well-known and readily-available polyols prepared from adipic acid and glycols such as ethylene glycol, diethylene glycol, butanediol, etc.

Petrochemical-derived polyester polyols may also be prepared in whole or in part from reclaimed or recycled content, including, for example, recycled or scrap polyethylene terephthalate (PET), distillation bottoms from dimethyl terephthalate manufacture, or coproducts from production of cyclohexanol and cyclohexanone via cyclohexane oxidation (“KA-coproduct-derived polyols”). KA-coproduct-derived polyols (“KACD polyols”) as described in U.S. Pat. No. 4,233,408 and WO2012173938A1 are of special interest in that they may offer cost advantages and reduced environmental impact compared to PPG polyols or polyester polyols not incorporating recycled/reclaimed content. KACD polyols are aliphatic polyester polyols that contain adipic and caprolactone monomeric units and potentially offer some of the performance characteristics of adipate and caprolactone polyols such as good adhesion at much lower cost and with environmental benefits of recycled content.

It can be observed that common polyester polyols such as the aforementioned adipates and analogous KACD polyols prepared using simple glycols such as ethylene glycol or diethylene glycol are not seamlessly interchangeable with PPG polyols in prepolymer formulations using naphthenic process oils. For example, a typical prepolymer is prepared using a PPG polyol with 56 mg KOH/g hydroxyl number by combining 1 part SUNDEX 840 process oil, 1.1 parts polyol, and 1.23 parts RUBINATE® M PMDI.² The resulting prepolymer is a homogeneous liquid that contains ˜30% process oil and ˜10% free NCO and has viscosity of ˜2000 cP at 23° C. An analogous prepolymer is prepared using KACD polyol made using diethylene glycol, with 175 mg KOH/g hydroxyl number (prepared according to Example 1 of WO2012173938A1), by combining 1 part SUNDEX 840 mineral oil, 0.88 parts polyol, and 1.46 parts RUBINATE® M PMDI. The resulting prepolymer contains the same 30% process oil and 10% free isocyanate as the PPG-based prepolymer, but phase separates to give a viscous lower layer and a thin upper layer of SUNDEX oil. Similar incompatibility and phase separation is observed with FOMREZ® E24-57 (mixed ethylene glycol-1,4-butanediol adipate from Chemtura, hydroxyl number 57 mg KOH/g) and with a simple diethylene glycol adipate (hydroxyl number 113 mg KOH/g).³ ² RUBINATE® is a registered trademark of Huntsman Corporation. SUNDEX 840 process oil is a product of HollyFrontier Refining and Marketing LLC.³ FOMREZ® is a registered trademark of Chemtura Corporation.

KACD polyester polyols and adipate polyols, when made using only simple glycols such as ethylene glycol or diethylene glycol, have a high density of ester linkages and are polar relative to polyether polyols such as PPG polyols which contain nonpolar ether linkages rather than polar ester linkages. It is believed that the high polarity of such polyester polyols renders them incompatible with the relatively nonpolar naphthenic process oils used in prepolymer formulations with PPG polyols.

Methods for using KACD polyols in prepolymers for REPUR applications include:
1) Use of polyol blends of KACD polyols with PPG polyols
2) Incorporation of low-polarity monomers in the KACD polyol to reduce its polarity
3) Use of more polar process oils

### Polyol Blends

Blends of KACD polyols with PPG polyols may be used in RFPUR applications. The amount of KACD polyol that can be blended into the final prepolymer without unacceptable phase separation depends on structure and polarity of the KACD polyol. Highly polar KACD polyols such as the polyol of Example 11 below may be used only at relatively low blend levels (˜25% by weight of the polyol component of the prepolymer in Prepolymer Example A was acceptable but ˜50% by weight showed phase separation). Low polarity KACD polyols can be used at levels from 50-100% of the polyol component of the prepolymer. For example, the KACD polyol of Polyol Example 2, made with the low-polarity monomer tall oil fatty acids (see below), can be used at 100%, as illustrated in Prepolymer Example D. Use of polyol blends is further illustrated by Prepolymer Examples G-K below.

### Use of Low-Polarity Monomers

It has been found that low-polarity KACD polyols can be prepared using low-polarity co-monomers. Reducing polarity of KACD polyols in this way imparts improved compatibility with conventional process oils used in PPG prepolymer formulations. Various low-polarity co-monomeric may be used, including poly(ethylene glycol), poly(propylene glycol), poly(butylene glycol), plant-derived fatty acids such as tall oil fatty acids (TOFA), plant- or animal-derived triglycerides (e.g. soybean oil, palm oil, coconut oil, tallow, etc), and others.

Use of longer chain glycols than ethylene glycol or diethylene glycol results in polyols with more ether linkages and fewer ester linkages for a given molecular weight product, reducing polarity of the resulting polyol. The longer chain glycols may be any low to mid-range molecular weight polyalkylene glycol. Longer chain glycols include those based on 2-carbon repeating units, including triethylene glycol, tetraethylene glycol, higher ethylene glycols, PEG 200, PEG 400, PEG 600, etc. Longer chain glycols may also be based on other repeating units such as 1,2-propylene-, 1,3-propylene-, 1,2-butylene, 1,3-butylene-, 1,4-butylene-, etc and may be branched or linear. This approach is illustrated by KACD Polyol Examples 5, 6, and 7 and by Prepolymer Examples H-L below.

When monofunctional materials like TOFA are used to reduce polarity of KACD polyols, it is desirable to also include higher functionality glycols such as glycerine, trimethylolpropane, pentaerythritol, sugars, etc to increase average functionality of the resulting polyol. It should be recognized that triglycerides may be employed as cost-effective functional equivalents of a mixture of long-chain fatty acids (e.g. TOFA) and glycerine. For example, the triglyceride glycerol trioleate may be regarded as equivalent to a mixture of the long-chain fatty acid oleic acid and glycerine. Under conditions used for preparation of a polyol, the triglyceride undergoes transesterification reactions so that one mole of triglyceride is functionally equivalent to one mole of glycerine and 3 moles of fatty acid. Triglycerides from different sources provide for different fatty acid content. This approach is illustrated by KACD Polyol Examples 2, 3, and 4 and by Prepolymer Examples D-G below.

### Polar Process Oils

Polar KACD polyols that are not compatible with prepolymer formulations using naphthenic oils may be used as the sole polyol component of a prepolymer binder when a more polar process oil is employed. Polar process oils may be used alone, or in combination with conventional prepolymer process oils such as naphthenic oils. The polar process oil may be admixed with the KACD polyol to make the change easier for the prepolymer manufacturer. Polar ester oils have found to work well, including for example diisobutyl succinate, diisobutyl glutarate, diisobutyl adipate, dioctyl adipate, 2,2,4-trimethyl-1,3-pentanediol diisobutyrate, trimethylolpropane trivalerate, glycerol triacetate (triacetin), glycerol tributyrate (tributyrin), polyol ester base fluids used in lubricants such as trimethylolpropane esters of mixed length monoacids (generally in the 5-10 carbon chain length range), and other ester fluids.

Use of polar process oils is illustrated by Prepolymer Examples B, C, E, F, and L below.

### KACD POLYOL EXAMPLES

### KACD Polyol Example 12

A KACD polyol is prepared using “nonvolatile residue” and diethylene glycol according to the general procedure of WO2012173938A1 Example 1 and found to have hydroxyl number 175 mg KOH/g.

### KACD Polyol Example 13

KACD polyols incorporating tall oil fatty acid are described in WO2012173938A1 Polyol Example 8. In the example below, pentaerythritol is included to compensate for the monofunctional TOFA and maintain higher average functionality in the product polyol.

A mixture of 113 g “nonvolatile residue” and 40 g XTOL® 304 tall oil fatty acid is charged to a short-path distillation apparatus, sparged with nitrogen, and heated to 153° C. while pressure is reduced to 300 mm Hg.⁴ Approximately 30 g of low boiling distillate is collected and removed. The remaining mixture is cooled to 25° C. and 0.05 g of titanium isopropoxide catalyst is added. The mixture is heated to 180° C. and pressure is reduced to ˜50 mm Hg; an additional 11 g distillate is collected and removed. The mixture is cooled and 63 g diethylene glycol and 9.6 g pentaerythritol are added. The mixture is heated to 215° C. while pressure is reduced to 12 mm Hg; an additional 60 g distillate is collected and removed. The resulting KACD polyol has acid number of 1.2 mg KOH/g, hydroxyl number of 166 mg KOH/g and viscosity of 518 cSt at 23° C. ⁴ XTOL® is a registered trademark of Georgia Pacific LLC.

### KACD Polyol Example 14

A mixture of 565 g “nonvolatile residue” is charged to a short-path distillation apparatus and heated to 235° C. at normal atmospheric pressure. Approximately 179 g of low boiling distillate is collected and removed. The reaction mixture is cooled to 85° C. and the following reactants added: 105 g diethylene glycol, 100 g DRAPEX® 6.8 epoxidized soybean oil.⁵ The reaction mixture is again heated to 235° C. and an additional 25 g distillate is collected and removed. Nitrogen sparge is introduced and 0.06 g of titanium isopropoxide catalyst is added. The mixture is heated to 235° C. and held at that temperature with nitrogen sparge; an additional 30 g distillate is collected and removed. Acid number is found to be 0.11 and hydroxyl number is 62 mg KOH/g. ⁵ DRAPER® is a registered trademark of Galata Chemicals LLC.

### KACD Polyol Example 15

A mixture of 565 g “nonvolatile residue” is charged to a short-path distillation apparatus and heated to 235° C. at normal atmospheric pressure. Approximately 175 g of low boiling distillate is collected and removed. The reaction mixture is cooled to 60° C. and the following reactants are added: 136 g diethylene glycol, 172 g soybean oil, 38 g glycerine, 1.25 g TYZOR® AC420 titanium-based esterification catalyst.⁶ The reaction mixture is heated to 235° C. and sparged with nitrogen until an additional 36 g distillate is collected and removed. Acid number of the resulting KACD Polyol 4 is found to be 0.53, hydroxyl number is 167 mg KOH/g, and viscosity is 275 cSt cSt at 24° C. ⁶ TYZOR® is a registered trademark of Dorf Ketal Specialty Catalysts.

### KACD Polyol Example 16

This example illustrates use of a mixture of tri- and tetra-ethylene glycol (˜88% triethylene glycol, ˜12% tetraethylene glycol).

A mixture of 565 g “nonvolatile residue” is charged to a short-path distillation apparatus and heated to 235° C. at normal atmospheric pressure. Approximately 180 g of low boiling distillate is collected and removed. The reaction mixture is cooled to less than 100° C., 242 g glycol mixture is added, and the reaction mixture reheated to 235° C. for 3 hours, during which time 25 g distillate is collected and removed. The reaction mixture is cooled, 1.25 g TYZOR® AC420 titanium-based esterification catalyst (Dorf Ketal) is added, and the mixture is heated to 235° C. and sparged with nitrogen until an additional 7 g distillate is collected and removed. Acid number of the resulting KACD Polyol 5 is found to be 0.25 mg KOH/g, hydroxyl number is 160 mg KOH/g, and viscosity is 300 cSt cSt at 23° C.

### KACD Polyol Example 17

A mixture of 565 g “nonvolatile residue” is charged to a short-path distillation apparatus and heated to 235° C. at normal atmospheric pressure. Approximately 180 g of low boiling distillate is collected and removed. The reaction mixture is cooled to less than 100° C., 934 g polyethylene glycol (˜600 Mn) is added, and the reaction mixture reheated to 235° C. for 3 hours, during which time 25 g distillate is collected and removed. The reaction mixture is cooled, 1.25 g TYZOR® AC420 titanium-based esterification catalyst (Dorf Ketal) is added, and the mixture is heated to 235° C. and sparged with nitrogen until an additional 7 g distillate is collected and removed. Acid number of the resulting KACD Polyol 6 is found to be 1.0 mg KOH/g and hydroxyl number is 165 mg KOH/g.

### KACD Polyol Example 18

This example illustrates preparation of a polyol using mixed poly propylene glycol (3% tripropylene glycol, 90% tetrapropylene glycol, 7% higher propylene glycols).

A mixture of 565 g “nonvolatile residue” is charged to a short-path distillation apparatus and heated to 235° C. at normal atmospheric pressure. Approximately 180 g of low boiling distillate is collected and removed. The reaction mixture is cooled to 60° C., 497 g mixed poly propylene glycol is added, and the reaction mixture reheated to 235° C. until 27 g distillate is collected and removed and acid number of the reaction mixture is 12 mg KOH/g. The reaction mixture is cooled, 0.23 g Tyzor® TPT-20B titanium-based esterification catalyst (Dorf Ketal) is added, and the mixture is heated to 235° C. and sparged with nitrogen until an additional 6 g distillate is collected and removed. Acid number of the resulting KACD Polyol 6 is found to be 0.7 mg KOH/g and hydroxyl number is 170 mg KOH/g.

### PGP-2000

The following examples use a commercial poly(propylene glycol) with hydroxyl number 56.3 (hydroxyl equivalent weight 996) available from Carpenter Co., 5016 Monument Ave., Richmond, Va. 23230.

### Prepolymer Examples

A. A prepolymer is made using 25% KACD polyol of Example 1 and 75% PPG2000 as follows: 7.8 parts by weight of this KACD polyol, 23.5 parts by weight PPG2000 polyol, 38.7 parts by weight RUBINATE® M PMDI, and 30.00 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.
B. A prepolymer is made using the KACD polyol of Example 1 as follows: 26.4 parts by weight of this KACD polyol, 43.6 parts by weight RUBINATE® M PMDI, and 30 parts by weight glycerol triacetate (triacetin) process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.
C. A prepolymer is made using the KACD polyol of Example 1 as follows: 26.4 parts by weight of this KACD polyol, 43.6 parts by weight RUBINATE® M PMDI, and 30 parts by weight diisobutyl adipate process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.
D. A prepolymer is made using the KACD polyol of Example 2 as follows: 26.8 parts by weight of this KACD polyol, 43.2 parts by weight RUBINATE® M PMDI, and 30 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to not show any separated oil phase.
E. A prepolymer is made using the KACD polyol of Example 3 as follows: 32.7 parts by weight of this KACD polyol, 37.3 parts by weight RUBINATE® M PMDI, and 30 parts by weight soybean oil methyl ester process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.
F. A prepolymer is made using the KACD polyol of Example 3 as follows: 32.7 parts by weight of this KACD polyol, 37.3 parts by weight RUBINATE® M PMDI, and 30 parts by weight glycerol tributyrate (tributyrin) process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.
G. A prepolymer is made using 50% KACD polyol of Example 4 and 50% PPG2000 as follows: 14.8 parts by weight of this KACD polyol, 14.8 parts by weight PPG2000 polyol, 40.5 parts by weight RUBINATE® M PMDI, and 30.0 parts by weight SUNDEX 840 process oil are combined, mixed thoroughly, and then heated at 80° C. for 16 hours to form the prepolymer. The resulting prepolymer, containing ˜30% process oil and ˜40% free NCO, is cooled to 23° C. and found to be a clear homogeneous liquid with no separated oil phase.
H. A prepolymer is made using 50% KACD polyol of Example 5 and 50% PPG2000 as follows: 14.9 parts by weight of this KACD polyol, 14.9 parts by weight PPG2000 polyol, 40.3 parts by weight RUBINATE® M PMDI, and 30.0 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to have no separated oil phase.
I. A prepolymer is made using 50% KACD polyol of Example 6 and 50% PPG2000 as follows: 14.8 parts by weight of this KACD polyol, 14.8 parts by weight PPG2000 polyol, 40.4 parts by weight RUBINATE® M PMDI, and 30.0 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to have no separated oil phase.
J. A prepolymer is made using 75% KACD polyol of Example 7 and 25% PPG2000 as follows: 21.0 parts by weight of this KACD polyol, 7.0 parts by weight PPG 2000, 42.0 parts by weight RUBINATE® M PMDI, and 30.0 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to not show any separated oil phase.
K. A prepolymer is made using 75% KACD polyol of Example 7 and 25% PPG2000 as follows: 21.0 parts by weight of this KACD polyol, 7.0 parts by weight PPG2000 polyol, 42.0 parts by weight RUBINATE® M PMDI, and 30.0 parts by weight SUNDEX 840 process oil are combined, mixed thoroughly, and then heated at 80° C. for 16 hours to form the prepolymer. The resulting prepolymer, containing ˜30% process oil and ˜10% free NCO, is cooled to 23° C. and found to not show any separated oil phase.
L. A prepolymer is made using the KACD polyol of Example 7 as follows: 26.6 parts by weight of this KACD polyol, 43.4 parts by weight RUBINATE® M PMDI, and 30 parts by weight glycerol triacetate (triacetin) process oil are combined, mixed thoroughly, and then heated at 80° C. for 16 hours to form the prepolymer. The resulting prepolymer, containing ˜30% process oil and ˜10% free NCO, is cooled to 23° C. and found to be a clear, homogeneous liquid with no separated oil phase.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

While the disclosure has been described and exemplified in sufficient detail for those skilled in this art to make and use it, various alternatives, modifications, and improvements will be apparent to those skilled in the art without departing from the spirit and scope of the claims.

All patents and publications referred to herein are incorporated by reference herein to the same extent as if each individual publication was specifically and individually indicated to be incorporated by reference in its entirety.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this disclosure as defined by the appended claims.

What is claimed is:

1. A method of manufacturing foam padding, comprising:
obtaining a pre-polymer composition, the pre-polymer composition comprising a polyol and a polyfunctional monomer, the polyol prepared by heating a byproduct mixture containing a non-volatile residue of a cyclohexane oxidation reaction product to remove monofunctional components to a concentration of about 0.01 wt % to about 26 wt % and water by distillation, the polyol further prepared by reacting the non-volatile residue of a cyclohexane oxidation reaction product with one or more polyhydroxy compounds;
mixing the pre-polymer composition with a recycled foam;
molding the recycled foam and the pre-polymer composition into a shape; and
curing the pre-polymer composition.

2. The method of claim 1, wherein the recycled foam is obtained from a preparative step of reducing the recycled foam in size such that the recycled foam has a width, length, and height from about ¼ inch to about ¾ inch.

3. The method of claim 1, wherein the step of curing includes polymerizing the pre-polymer composition resulting in the foam padding.

4. The method of claim 1, wherein the non-volatile residue of a cyclohexane oxidation reaction product is concentrated prior to formation of the polyol, and wherein the polyol is prepared from the non-volatile residue of a cyclohexane oxidation reaction product under vacuum or under an inert gas.

5. The method of claim 1, wherein the polyhydroxy compound comprises at least one of a diol, a triol, a tetraol, a saccharide and a sugar alcohol.

6. The method of claim 1, wherein the polyhydroxy compound is at least one of ethylene glycol, diethylene glycol, polyethelene glycol, propylene glycol, dipropylene glycol, polypropylene glycol, butanediol, pentanediol, hexanediol, glycerine, trimethylolpropane, pentaerythritol and sorbitol.

7. The method of claim 1, wherein the polyol is further prepared by heating the byproduct mixture prior to adding the one or more polyhydroxy compound, then, after adding the one or more polyhydroxy compounds, continuing to heat the resulting mixture.

8. The method of claim 1, wherein the polyol composition is further prepared by adding to the byproduct mixture a third component comprising a polyfunctional acid, an activated ester thereof, a polyfunctional ester thereof, an anhydride thereof, or a mixture thereof, to the byproduct mixture, then heating and removing the monofunctional compounds by distillation.

9. The method of claim 8, wherein the third component comprises a polyfunctional aromatic acid, an anhydride thereof, an activated ester thereof, a polyfunctional ester thereof, or a mixture thereof.

10. The method of claim 9, wherein the third component comprises terephthalic acid, isophthalic acid, orthophthalic acid, trimellitic acid, pyromellitic acid, an activated ester thereof, a polyfunctional ester thereof, an anhydride thereof, or a mixture thereof.

11. The method of claim 8, wherein the third component comprises a polyfunctional aliphatic acid, an activated ester thereof, a polyfunctional ester thereof, an anhydride thereof, or a mixture thereof.

12. The method of claim 11, wherein the third component comprises glycolic acid, citric acid, lactic acid, malic acid, aspartic acid, furmaric acid, maleic acid, succinic acid, glutaric acid, adipic acid, an activated ester thereof, a polyfunctional ester thereof, an anhydride thereof, or a mixture thereof.

13. The method of claim 1, wherein the shape is a block or a cylinder.

14. The method of claim 13, wherein the shape is further processed into the foam padding.

15. The method of claim 1, wherein the recycled foam comprises a polyurethane polymer.

16. The method of claim 1, wherein the polyfunctional monomer is a polyfunctional isocyanate; and the polyfunctional isocyanate is monomeric methylene diphenyl diisocyanate (MDI), polymeric MDI, an aliphatic diisocyanate, a cycloaliphatic diisocyanate, an aromatic diisocyanate, a multifunctional aromatic isocyanate, an organic polyisocyanate, a modified polyisocyanate, an isocyanate-based pre-polymer, or a mixture thereof

17. The method of claim 1, comprising adhering a barrier film to a surface of the foam padding.

18. A foam padding, comprising:
recycled foam; and
a polyurethane binder polymerized from a polyol and a polyfunctional monomer, the polyurethane binder containing monofunctional components including butyric acid, valeric acid, and caproic acid, the monofunctional components present in the polyurethane binder in an amount from about 0.01 wt % to about 26 wt % based on weight of contained polyol.

19. The foam padding of claim 18, wherein the recycled foam comprises a polyurethane polymer.

20. The foam padding of claim 18, wherein the polymerized polyfunctional monomer is a polyfunctional isocyanate.

21. The foam padding of claim 18, wherein the butyric acid is present in an amount from about 0.01 wt % to about 5 wt %, the valeric acid is present in an amount from about 0.05 wt % to about 15 wt %, and the caproic acid is present in an amount from about 0.01 wt % to about 6 wt % based on weight of contained polyol.

22. The foam padding of claim 18, wherein the butyric acid is present in an amount from about 0.2 wt % to about 0.8 wt %, the valeric acid is present in an amount from about 2 wt % to about 7 wt %, and the caproic acid is present in an amount from about 1.5 wt % to about 3.5 wt % based on weight of contained polyol.

23. The foam padding of claim 18, wherein the polyurethane binder contains levulinic acid and multifunctional compounds including hydroxycaproic acid and adipic acid.

24. The foam padding of claim 23, wherein the levulinic acid is present in an amount from about 0.01 wt % to about 5 wt %, the hydroxycaproic acid is present in an amount from about 3 wt % to about 45 wt %, and the adipic acid is present in an amount from about 3 wt % to about 35 wt % based on weight of contained polyol.

25. The foam padding of claim 18, further comprising a barrier film bonded to a surface of the foam padding.

26. The foam padding of claim 25, wherein the barrier is formed from vulcanized silicone rubber, silicone polymer, polyurethanes, polyether/polyester, polyether/amides, polyvinyl alcohol, copolymers thereof, or blends thereof.

27. The foam padding of claim 25, further comprising an adhesive material that bonds the barrier film to the foam padding.

28. The foam padding of claim 18, wherein the recycled foam is present in the padding in an amount of about 80 wt % to 99 wt %.

29. The foam padding of claim 18, wherein the polyurethane binder is present in the padding in an amount of about 1 wt % to 20 wt %, for example, 5-15 wt %.

30. The foam padding of claim 18, wherein the recycled foam and polyurethane binder are present in the padding at a ratio ranging from 4:1 to 99:1.

31. The foam padding of claim 18, wherein a remaining content of the monofunctional components is about 10 wt % or less.

32. The foam padding of claim 18, wherein the polyol composition has an OH value of about 50 to 500 mg KOH/gm; and wherein the composition has an acid number of less than 10 mg KOH/gm of sample.

33. The foam padding of claim 18, wherein the polyol is prepared from a byproduct mixture from an adipic acid manufacturing process, or a byproduct mixture from a caprolactam manufacturing process, or a mixture thereof.

34. The foam padding of claim 33, wherein the polyol is prepared from the byproduct mixture and a polyhydroxy compound, the polyhydroxy compound comprising at least one of a diol, a triol, a tetraol, a saccharide and a sugar alcohol.

35. The foam padding of claim 34, wherein the polyhydroxy compound is at least one of ethylene glycol, diethylene glycol, polyethelene glycol, propylene glycol, dipropylene glycol, polypropylene glycol, butanediol, pentanediol, hexanediol, glycerine, trimethylolpropane, pentaerythritol and sorbitol.

36. A method of manufacturing a fiber-reinforced composite material, comprising:
obtaining a pre-polymer composition, the pre-polymer composition comprising a polyol and a polyfunctional monomer, the polyol prepared by heating a byproduct mixture containing a non-volatile residue of a cyclohexane oxidation reaction product to remove monofunctional components to a concentration of about 0.01 wt % to about 26 wt % and water by distillation, the polyol further prepared by reacting the non-volatile residue of a cyclohexane oxidation reaction product with one or more polyhydroxy compounds;
contacting a fiber substance with the pre-polymer composition; and
curing the pre-polymer composition.

37. The method of claim 36, wherein the step of curing includes polymerizing the polyol and the polyfunctional monomer.

38. The method of claim 36, wherein the step of curing is under conditions suitable for the pre-polymer composition to form a solid polymer material

39. The method of claim 36, wherein the non-volatile residue of the cyclohexane oxidation reaction product is concentrated prior to formation of the polyol and wherein the polyol is prepared from the non-volatile residue of the cyclohexane oxidation reaction product under vacuum or under an inert gas.

40. The method of claim 36, wherein the polyfunctional monomer is a polyfunctional isocyanate.

41. The method of claim 40, wherein the polyfunctional isocyanate is monomeric methylene diphenyl diisocyanate (MDI), polymeric MDI, an aliphatic diisocyanate, a cycloaliphatic diisocyanate, an aromatic diisocyanate, a multifunctional aromatic isocyanate, an organic polyisocyanate, a modified polyisocyanate, an isocyanate-based pre-polymer, or a mixture thereof.

42. The method of claim 36, wherein the polyol is further prepared by heating the byproduct mixture prior to adding the one or more polyhydroxy compounds, then, after adding the one or more polyhydroxy compounds, continuing to heat the resulting mixture.

43. The method of claim 36, wherein the polyol is further prepared by adding to the byproduct mixture a third component comprising a polyfunctional acid, an activated ester thereof, a polyfunctional ester thereof, an anhydride thereof, or a mixture thereof, to the byproduct mixture, then heating and removing the monofunctional compounds by distillation.

44. The method of claim 43, wherein the third component comprises a polyfunctional aromatic acid, an anhydride thereof, an activated ester thereof, a polyfunctional ester thereof, or a mixture or combination thereof.

45. The method of claim 44, wherein the third component comprises at least one of terephthalic acid, isophthalic acid, orthophthalic acid, trimellitic acid, pyromellitic acid, an activated ester thereof, a polyfunctional ester thereof and an anhydride thereof.

46. The method of claim 43, wherein the third component comprises at least one of a polyfunctional aliphatic acid, an activated ester thereof, a polyfunctional ester thereof.

47. The method of claim 46, wherein the third component comprises at least one of glycolic acid, citric acid, lactic acid, malic acid, aspartic acid, furmaric acid, maleic acid, succinic acid, glutaric acid, adipic acid, an activated ester thereof, a polyfunctional ester thereof, and an anhydride thereof.

48. The method of claim 36, wherein the polyhydroxy compound comprises at least one of a diol, a triol, a tetraol, a saccharide and a sugar alcohol.

49. The method of claim 36, wherein the polyhydroxy compound is at least one of ethylene glycol, diethylene glycol, polyethelene glycol, propylene glycol, dipropylene glycol, polypropylene glycol, butanediol, pentanediol, hexanediol, glycerine, trimethylolpropane, pentaerythritol and sorbitol.

50. A fiber-reinforced composite material, comprising:
a fiber substance; and
a polyurethane binder polymerized from a polyol and a polyfunctional monomer, the polyurethane binder containing monofunctional components including butyric acid, valeric acid, and caproic acid, the monofunctional components present in the polyurethane binder in an amount from about 0.01 wt % to about 26 wt % based on weight of contained polyol.

51. The fiber-reinforced composite material of claim 50, wherein the fiber substance is cellulosic.

52. The fiber-reinforced composite material of claim 50, wherein the cellulosic substance comprises wood fibers.

53. The fiber-reinforced composite material of claim 50, wherein the polymerized polyfunctional monomer is a polyfunctional isocyanate.

54. The fiber-reinforced composite material of claim 50, wherein the polyurethane binder is present in the fiber-reinforced composite material in an amount of about 1 wt % to 50 wt %, for example, 5-20 wt %.

55. The fiber-reinforced composite material of claim 50, wherein the fiber substance is present in the fiber-reinforced composite material in an amount of about 50 wt % to 99 wt %.

56. The fiber-reinforced composite material of claim 50, wherein the fiber substance and polyurethane binder are present in the fiber-reinforced composite material at a ratio ranging from 1:1 to 99:1.

57. The fiber-reinforced composite material of claim 50, wherein the butyric acid is present in an amount from about 0.01 wt % to about 5 wt %, the valeric acid is present in an amount from about 0.05 wt % to about 15 wt %, and the caproic acid is present in an amount from about 0.01 wt % to about 6 wt % based on weight of contained polyol.

58. The fiber-reinforced composite material of claim 50, wherein the butyric acid is present in an amount from about 0.2 wt % to about 0.8 wt %, the valeric acid is present in an amount from about 2 wt % to about 7 wt %, and the caproic acid is present in an amount from about 1.5 wt % to about 3.5 wt % based on weight of contained polyol.

59. The fiber-reinforced composite material of claim 50, wherein the polyurethane binder contains levulinic acid and multifunctional compounds including hydroxycaproic acid and adipic acid.

60. The fiber-reinforced composite material of claim 59, wherein the levulinic acid is present in an amount from about 0.01 wt % to about 5 wt %, the hydroxycaproic acid is present in an amount from about 3 wt % to about 45 wt %, and the adipic acid is present in an amount from about 3 wt % to about 35 wt % based on weight of contained polyol.

61. The fiber-reinforced composite material of claim 50, wherein the polyol composition has an OH value of about 50 to 500 mg KOH/gm; and wherein the composition has an acid number of less than 10 mg KOH/gm.

62. The fiber-reinforced composite material of claim 50, wherein the polyol is prepared from a byproduct mixture from an adipic acid manufacturing process, or a byproduct mixture from a caprolactam manufacturing process, or a mixture thereof.

63. The fiber-reinforced composite material of claim 62, wherein polyol is prepared from the byproduct mixture and a polyhydroxy compound comprising a diol, a triol, a tetraol, a saccharide, a sugar alcohol, or mixture or combination thereof.

64. The fiber-reinforced composite material of claim 63, wherein the polyhydroxy compound is ethylene glycol, diethylene glycol, polyethelene glycol, propylene glycol, dipropylene glycol, polypropylene glycol, butanediol, pentanediol, hexanediol, glycerine, trimethylolpropane, pentaerythritol, sorbitol, or a mixture or combination thereof.

65. A resin blend, comprising a polyol, the polyol containing monofunctional components including butyric acid, valeric acid, and caproic acid, the monofunctional components present in the resin blend in an amount from about 0.01 wt % to about 26 wt % based on weight of contained polyol.

66. The resin blend of claim 65, wherein the butyric acid is present in an amount from about 0.01 wt % to about 5 wt %, the valeric acid is present in an amount from about 0.05 wt % to about 15 wt %, and the caproic acid is present in an amount from about 0.01 wt % to about 6 wt % based on weight of contained polyol.

67. The resin blend of claim 65, wherein the butyric acid is present in an amount from about 0.2 wt % to about 0.8 wt %, the valeric acid is present in an amount from about 2 wt % to about 7 wt %, and the caproic acid is present in an amount from about 1.5 wt % to about 3.5 wt % based on weight of contained polyol.

68. The resin blend of claim 65, wherein the polyurethane binder contains levulinic acid and multifunctional compounds including: hydroxycaproic acid and adipic acid.

69. The resin blend of claim 68, wherein the levulinic acid is present in an amount from about 0.01 wt % to about 5 wt %, the hydroxycaproic acid is present in an amount from about 3 wt % to about 45 wt %, and the adipic acid is present in an amount from about 3 wt % to about 35 wt % based on weight of contained polyol.

70. The resin blend of claim 65, further comprising a catalyst, a chain extender, a crosslinking agent, a curative, a surfactant, a blowing agent, a filler, a flame retardant, a plasticizer, a light stabilizer, a colorant, a wax, a biocide, a mineral, a micronutrient, an inhibitor, a stabilizer, an organic additive, an inorganic additive, or mixtures thereof.

71. A pre-polymer composition, comprising the resin blend of claim 65 and a polyfunctional monomer.

72. The pre-polymer composition of claim 71, wherein the polyfunctional monomer is a polyfunctional isocyanate.

73. The pre-polymer composition of claim 72, wherein the polyfunctional isocyanate is selected from the group consisting of: monomeric methylene diphenyl diisocyanate (MDI), polymeric MDI, an aliphatic diisocyanate, a cycloaliphatic diisocyanate, an aromatic diisocyanate, a multifunctional aromatic isocyanate, an organic polyisocyanate, a modified polyisocyanate, an isocyanate-based pre-polymer, or a mixture thereof.

74. The pre-polymer composition of claim 71, further comprising an oil.

75. The pre-polymer composition of claim 74, wherein the oil is selected from the group consisting of: a hydrocarbon oil, an animal oil, tallow oil, soybean oil, coconut oil, castor oil, linseed oil, a nonedibile plant-derived oil, an edible plant-derived oil, a synthetic oil, and mixtures thereof.

76. The pre-polymer composition of claim 74, wherein the prepolymer contains 5-20% NCO.
